(19) United States
(12) Patent Application Publication
(10) Pub. No.: US 2025/0342758 A1
(43) Pub. Date: Nov. 6, 2025

(54) SYSTEM USING AIR PRESSURE DATA FOR SECURITY AND HAZARD DETECTION

(71) Applicant: Ademco Inc., Golden Valley, MN (US)

(72) Inventors: James T. Woolaway, Carbondale, CO (US); Travis Read, Little Canada, MN (US); John Edward Cronin, Jericho, VT (US); Kenneth Eskildsen, Great Neck, NY (US); Jeff Frank, Richmond (NZ); William R. Blum, Huntington Station, NY (US)

(73) Assignee: Ademco Inc., Golden Valley, MN (US)

(21) Appl. No.: 18/866,310

(22) PCT Filed: May 25, 2023
(86) PCT No.: PCT/US2023/023518

§ 371 Date: Nov. 15, 2024

Related U.S. Application Data
(60) Provisional application No. 63/348,190, filed on Jun. 2, 2022.

(51) Int. Cl. G08B 13/20; G08B 29/18

(52) U.S. Cl. CPC G08B 13/20; G08B 29/188

(57) ABSTRACT

A system includes a controller and a first pressure sensor. The first pressure sensor is configured to detect a first air pressure within a premises at a first time and a second air pressure within the premises at a second time. The first pressure sensor is in communication with the controller. The controller is configured to receive the first air pressure and the second air pressure within the premises from the first pressure sensor, determine a change in pressure within the premises using at least the first air pressure and the second air pressure, and compare the change in pressure within the premises to a first predetermined interior pressure change threshold. When the change in pressure within the premises matches the first predetermined interior pressure change threshold, the controller is configured to determine a first output associated with the first predetermined interior pressure change threshold.

### RELATED APPLICATIONS

This application claims priority to U.S. Provisional Application No. 63/348,190, filed Jun. 2, 2022, the entire content of which is incorporated by reference herein.

### TECHNICAL FIELD

This disclosure relates generally to the use of pressure data to detect one or more security and/or hazard condition at a premises, and, in certain specific embodiments, this disclosure discloses the use of pressure data within and/or external a premises for determining one or more actions to be taken in view of the detected one or more security and/or hazard condition at the premises. As one example, this disclosure describes the use of pressure data within and/or external a premises for determining one or control more actions to be taken at a heating and ventilation and air conditioning (“HVAC”) system, and, in some such cases, executing one of more control actions at the HVAC system based on the pressure data within and/or external the premises. Embodiments disclosed herein can be applied in, for example, home automation, comfort, and/or security systems and networks.

### BACKGROUND

Security and hazard conditions have traditionally been detected at a premises using a plurality of cameras, motion detectors, and fire detectors. However, data collected using such traditional cameras, motion detectors, and fire detectors can be limited and, as a result, limit actions that can be taken, or otherwise informed, based on this data. For example, certain types of conditions at a premises can potentially go undetected where the sensitivity of the camera, motion detector, or fire detector is not set, or capable of detection, at a level needed to detect such certain types of conditions or, more generally, where such traditional security and hazard detectors are incapable of detecting an appropriate parameter for certain types of conditions. On the other hand, where the sensitivity of the camera, motion detector, or fire detector is set at too fine of a level, certain types of conditions may trigger false alarms. As another example, one or more actions to be taken as a result of certain types of detected conditions at a premises may benefit from data that allows for deriving an anticipated future event, such as a weather-related event or location a person present at the premises is moving toward, and the noted traditional security and hazard detectors may not be sufficient to derive a reasonable prediction for an anticipated future event.

### SUMMARY

In general, this disclosure relates to devices, systems, and methods for using premises pressure data, in some cases along with other types of data, to detect one or more certain types of conditions at the premises and, in some further such cases, cause one or more premise-based system adjustments based, at least in part, on the premises pressure data. Embodiments disclosed herein can utilize pressure data to determine one or more characteristics at a premises indicative of one or more types of conditions present at, or predicted to be present at, the premises, and, in some such embodiments, this pressure data (e.g., and the determined one or more characteristics at a premises indicative of one or more types of conditions present at, or predicted to be present at, the premises based on the pressure data) can be used to determine one or more actions to be taken at the premises. Examples of such one or more actions to be taken at the premises based on this pressure data (e.g., and the determined one or more characteristics at a premises indicative of one or more types of conditions present at, or predicted to be present at, the premises based on the pressure data) can include one or more actions to be taken by the premises HVAC system or other controllable premises system (e.g., door (e.g., garage door) or window opening/closing system) as a result of the one or more characteristics at the premises determined from the pressure data.

As one such example, embodiments described in this disclosure can utilize pressure data at a premises to manage air flow within the premises in a desired manner. In some such embodiments, based on the pressure data detected at the premises (e.g., interior to the premises and/or exterior to the premises), a controller can take one or more actions to cause an adjustment in air flow at the premises (e.g., at a specific zone of the premises). For instance, based on the pressure data at the premises, the controller can actuate one or more dampers at the premises (e.g., at an air duct, such as adjacent an air duct inlet and/or outlet) to cause an adjusted air flow at a particular, corresponding zone of the premises. In the case of the adjusted air flow within the premises resulting from the controller's actuation of the one or more dampers, this can, for instance, cause air to flow to move from one zone to another zone or even potentially substantially halt air flow to a particular zone for a limited period of time. This can be useful, for instance, in adjusting air flow within the premises based on a change in detected pressure within the premises matching a first predetermined interior pressure change threshold, which match could correspond to one or more of an opened door or window, a presence of a person at the premises, and a presence of an interior hazard (e.g., gas and/or fire). The ability to leverage detected pressure change to adjust air flow within the premises can thus, in some embodiments, allow for increased HVAC efficiency, for instance by adjusting air flow to reduce inefficiency resulting from the opened door or window and/or by adjusting air flow in a manner accounting for the location of the person present at the premises. Also, in some embodiments, the ability to leverage detected pressure change to adjust air flow within the premises can allow for reducing potential harm posed by a detected interior hazard (e.g., gas and/or fire) in a manner that reduces air flow to a location of the interior hazard (e.g., fire) or directs air flow to a location of the interior hazard to help remediate the interior hazard at that location (e.g., gas).

As another such example, embodiments described in this disclosure can utilize pressure data at a premises to determine a security action to be taken. In some such embodiments, based on the pressure data detected at the premises (e.g., interior to the premises and/or exterior to the premises), a controller can take one or more actions to cause a security action pertaining to the premises to be selected and output. For instance, when a change in pressure with the premises matches a first predetermined interior pressure change threshold, the controller can determine a first security output associated with the first predetermined interior pressure change threshold. As one example, the first predetermined interior pressure change threshold can be associated with a presence of an intruder at the premises (e.g., because the controller received an input that an occupant has left the premises and while the occupant is away from the premises the controller determines that a change in pressure with the premises matches the first predetermined interior pressure change threshold), and the controller can be configured to determine a first security output associated with the presence of an intruder at the premises, which could be, for instance, a notification to a remote device (e.g., a remote server; a remote user device, such as a mobile phone; a remote monitoring station) and/or actuation of a premises security device (e.g., recording video at a camera at the premises; turning on a siren at the premises; actuating an alarm condition at a security system at the premises; turning on one or more lights at the premises).

As a further such example, embodiments described in this disclosure can utilize pressure data at a premises to determine a hazard remediation action to be taken. In some such embodiments, based on the pressure data detected at the premises (e.g., interior to the premises and/or exterior to the premises), a controller can take one or more actions to cause a hazard remediation action pertaining to the premises to be selected and output. For instance, when a change in pressure with the premises matches a first predetermined interior pressure change threshold, the controller can determine an action to be taken at a device at the premises to remediate the particular detected hazard condition. As one example, the first predetermined interior pressure change threshold can be associated with a presence of a vehicle at an enclosed parking structure at the premises (e.g., because the controller received pressure measurement inputs at the enclosed parking structure to determine that a change in pressure at the enclosed parking structure matches the first predetermined interior pressure change threshold associated with the presence of the vehicle at the enclosed parking structure), and the controller can be configured to determine a first output associated with the presence of the vehicle at the enclosed parking structure, which could be, for instance, a notification to a remote device (e.g., a remote server; a remote user device, such as a mobile phone; a remote monitoring station) and/or actuation of a premises device (e.g., outputting an actuation command to cause a garage door actuator to open of close a garage door at the enclosed parking structure). As another example, the first predetermined interior pressure change threshold can be associated with opening of a door or window and a first predetermined exterior pressure change threshold can be associated with a weather condition exterior to the premises (e.g., storm; hurricane; tornado; wild fire; etc.), and, when a change in pressure exterior to the premises matches the first predetermined exterior pressure change threshold, the controller can be configured to generate a door or window alert, for instance indicating that a door or window is open at the premises but is recommend to be closed given the current or anticipated weather condition exterior to the premises.

One embodiment includes a system. This system embodiment includes a controller and a first pressure sensor. The first pressure sensor is configured to detect a first air pressure within a premises at a first time and a second air pressure within the premises at a second time, where the first time is different than the second time. The first pressure sensor is in communication with the controller. The controller is configured to receive the first air pressure and the second air pressure within the premises from the first pressure sensor, determine a change in pressure within the premises using at least the first air pressure and the second air pressure, and compare the change in pressure within the premises to a first predetermined interior pressure change threshold. When the change in pressure within the premises matches the first predetermined interior pressure change threshold, the controller is configured to determine a first output associated with the first predetermined interior pressure change threshold.

In a further embodiment of this system, the first predetermined interior pressure change threshold corresponds to opening of a door or window, and the first output determined by the controller as associated with the first predetermined interior pressure change threshold is an entry alert to a remote device. In an such exemplary embodiment, the controller is further configured to compare the change in pressure within the premises to a second predetermined interior pressure change threshold, and, when the change in pressure within the premises matches the second predetermined interior pressure change threshold, determine a second output associated with the second predetermined interior pressure change threshold, where the second predetermined interior pressure change threshold is different than the first predetermined interior pressure change threshold. For instance, the second predetermined interior pressure change threshold can correspond to a presence of a person at the premises, and the second output determined by the controller as associated with the second predetermined interior pressure change threshold can be an intruder alert to a remote device.

In a further embodiment of this system, the system further includes a security sensor in communication with the controller. The controller is further configured to receive security data at the premises from the security sensor and, when both the change in pressure within the premises matches the first predetermined interior pressure change threshold and the security data matches a first predetermined premises security threshold, the controller is configured to determine a first output associated with each of the first predetermined interior pressure change threshold and the first predetermined premises security threshold.

In a further embodiment of this system, the system further includes a heating, ventilation, and air conditioning (HVAC) unit at the premises and in communication with the controller. The first output associated with the first predetermined interior pressure change threshold is a HVAC adjustment command such that, when the change in pressure within the premises matches the first predetermined interior pressure change threshold, the controller is configured to transmit the HVAC adjustment command to the HVAC unit. In one such exemplary embodiment, the first predetermined interior pressure change threshold corresponds to a presence of an interior hazard within the premises, and the first output determined by the controller as associated with the first predetermined interior pressure change threshold is an HVAC adjustment command to the HVAC unit. For instance, the interior hazard can be a fire, and the HVAC adjustment command can be a damper adjustment command to restrict air supply provided within the premises. In such exemplary embodiment where the first predetermined interior pressure change threshold corresponds to a presence of an interior hazard within the premises and the first output determined by the controller as associated with the first predetermined interior pressure change threshold is an HVAC adjustment command to the HVAC unit, the system can further include a gas or fire sensor in communication with the controller, and the controller can be further configured to receive gas or fire data at the premises from the gas or fire sensor and, when both the change in pressure within the premises matches the first predetermined interior pressure change threshold and the gas or fire data matches a first predetermined premises gas or fire threshold, the controller can be further configured to determine a first output associated with each of the first predetermined interior pressure change threshold and the first predetermined premises gas or fire threshold. In another exemplary embodiment where the system includes the HVAC unit and the first output associated with the first predetermined interior pressure change threshold is a HVAC adjustment command, the first predetermined interior pressure change threshold can correspond to a presence of a person within the premises, and the first output determined by the controller as associated with the first predetermined interior pressure change threshold can be an HVAC adjustment command to the HVAC unit to change a temperature set point setting.

In a further embodiment of this system, the system further includes a second pressure sensor configured to detect a third air pressure exterior to the premises at a third time and a fourth air pressure exterior to the premises at a fourth time, where the third time is different than the fourth time. The second pressure sensor is in communication with the controller. The controller is configured to receive the third air pressure and the fourth air pressure exterior to the premises from the second pressure sensor, determine a change in pressure exterior to the premises using at least the third air pressure and the fourth air pressure, compare the change in pressure exterior to the premises to a first predetermined exterior pressure change threshold, and, when the change in pressure exterior to the premises matches the first predetermined exterior pressure change threshold, the controller is configured to determine a second output associated with the first predetermined exterior pressure change threshold. In one such exemplary embodiment, the first predetermined exterior pressure change threshold corresponds to a weather condition exterior to the premises, and the second output determined by the controller as associated with the first predetermined exterior pressure change threshold is a weather condition alert to a remote device. In another such exemplary embodiment, the first predetermined interior pressure change threshold corresponds to opening of a door or window, the first predetermined exterior pressure change threshold corresponds to a weather condition exterior to the premises, and, when both the change in pressure within the premises matches the first predetermined interior pressure change threshold and the change in pressure exterior to the premises matches the first predetermined exterior pressure change threshold, the controller is configured to generate a door or window alert to a remote device. For instance, the first predetermined exterior pressure change threshold can correspond to a first weather condition exterior to the premises and a second predetermined exterior pressure change threshold can correspond to a second weather condition exterior to the premises, and, when the change in pressure exterior to the premises matches the first predetermined exterior pressure change threshold, the controller can be configured to generate the door or window alert to the remote device, and, when the change in pressure exterior to the premises matches the second predetermined exterior pressure change threshold, the controller is configured to generate a shelter alert to a remote device. In another such exemplary embodiment, the first predetermined exterior pressure change threshold can correspond to a weather condition exterior to the premises, and the second output determined by the controller as associated with the first predetermined exterior pressure change threshold can be a damper adjustment command to adjust an air damper at the premises to change a volume of air passing through the damper.

In a further embodiment of this system, the first predetermined interior pressure change threshold corresponds to a presence of a vehicle at an enclosed parking structure at the premises. In one such exemplary embodiment, this system can further include a garage door actuator configured to open and close a garage door at the enclosed parking structure, and the first output determined by the controller as associated with the first predetermined interior pressure change threshold can be an actuation command to cause the garage door actuator to open or close the garage door at the enclosed parking structure. For instance, this exemplary system embodiment can further include a gas sensor configured to detect a concentration of gas at the enclosed parking structure and the gas sensor can be in communication with the controller. The controller can be configured to receive the concentration of gas at the enclosed parking structure from the gas sensor, compare the concentration of gas to a first predetermined gas threshold, and, when the change in pressure within the enclosed parking structure matches the first predetermined interior pressure change threshold and the concentration of gas matches the first predetermined gas threshold, the controller can be configured to generate the actuation command to cause the garage door actuator to open the garage door. In a further such instance, the first predetermined interior pressure change threshold can correspond to a presence of a vehicle with a running motor at an enclosed parking structure at the premises, and the controller can determine that the change in pressure within the enclosed parking structure matches the first predetermined interior pressure change threshold prior to determining that the concentration of gas matches the first predetermined gas threshold. In another such exemplary embodiment, the first output determined by the controller as associated with the first predetermined interior pressure change threshold can be a damper adjustment command to adjust an air damper in fluid communication with the enclosed parking structure to change a volume of air passing through the damper.

Another embodiment includes a method for using sensor data to detect one or more security, hazard, and/or weather conditions at a premises and determine one or more outputs associated with the detected one or more security, hazard, and/or weather conditions at the premises. This method embodiment includes the steps of receiving sensor data (e.g., from a pressure sensor interior to the premises and/or from a pressure sensor exterior to the premises), determining a change in at least one data parameter of the received sensor data (e.g., a change in pressure interior to the premises and/or exterior to the premises), and comparing the change in the at least one data parameter to a predetermined data change threshold (e.g., a predetermined interior pressure change threshold and/or a predetermined exterior pressure change threshold). And, this method embodiment further includes, when the change in the at least one data parameter matches the predetermined data change threshold, the step of determining at least one output associated with at least one safety, hazard, and/or weather condition that corresponds to the predetermined data change threshold. One example of this output determination step can include causing a security system alarm condition to be actuated at the premises as associated with a presence of an intruder that corresponds at least to the interior change in pressure matching a predetermined interior pressure change threshold. Another example of this output determination step can include causing an adjustment to a component of a HVAC system at the premises as associated with a presence of a fire or gas leak that corresponds at least to the interior change in pressure matching a predetermined interior pressure change threshold. A still further example of this output determination step can include causing an alert to be generated as associated with an open door/window state at the premises at a time when a weather event is occurring, or anticipated to occur, that corresponds at least to the exterior change in pressure at the premises matching a predetermined exterior pressure change threshold.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a block diagram illustrating an example of a premises with pressure sensors, in accordance with one or more techniques described herein.

FIG. 2 is a block diagram illustrating an example system, such as for use, at least in part, at a premises with one or more pressure sensors, such as that shown at FIG. 1, in accordance with one or more techniques described herein.

FIG. 3 is a block diagram illustrating an example of a premises network, in accordance with one or more techniques described herein.

FIG. 4 is a block diagram illustrating an example system for determining and causing an output associated with at least a change in pressure, in accordance with one or more techniques described herein.

FIG. 5 is a block diagram illustrating an example of a premises with pressure sensors and a HVAC system, including dampers for controlling conditioned air, exterior source air, and return air flow at zones of the premises, in accordance with one or more techniques described herein.

FIG. 6 is a diagram illustrating a damper, at an air duct, configured to incrementally control air flow, via one or more damper positions incrementally between fully closed and fully open, in accordance with one or more techniques described herein.

FIG. 7 is a block diagram illustrating a controller for determining and causing an output that is associated at least with a change in pressure, in accordance with one or more techniques described herein.

FIG. 8 is a block diagram illustrating an example system for detecting a hazard condition at an enclosed parking structure, in accordance with one or more techniques described herein.

FIG. 9 is a flow diagram illustrating an example of a method for using sensor data to detect one or more security, hazard, and/or weather conditions at a premises and determine one or more outputs associated with the detected one or more security, hazard, and/or weather conditions at the premises.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

This disclosure describes embodiments that utilize at least pressure data to determine one or more characteristics at a premises that can be used to determine one or more actions to be taken at the premises. For instance, embodiments disclosed herein can determine one or more actions to be taken related to a premises device (e.g., HVAC system, security system, door and/or window at the premises) as a result of the one or more characteristics at the premises determined from at least the pressure data.

As one such example, embodiments described in this disclosure can utilize pressure data at a premises to manage air flow within the premises in a desired manner. In some such embodiments, based on the pressure data detected at the premises (e.g., interior to the premises and/or exterior to the premises), a controller can take one or more actions to cause an adjustment in air flow at the premises (e.g., at a specific zone of the premises). For instance, based on the pressure data at the premises, the controller can actuate one or more dampers at the premises (e.g., at an air duct, such as adjacent an air duct inlet and/or outlet) to cause an adjusted air flow at a particular, corresponding zone of the premises.

As another such example, embodiments described in this disclosure can utilize pressure data at a premises to determine a security action to be taken. In some such embodiments, based on the pressure data detected at the premises (e.g., interior to the premises and/or exterior to the premises), a controller can take one or more actions to cause a security action pertaining to the premises to be selected and output. For instance, when a change in pressure with the premises matches a first predetermined interior pressure change threshold, the controller can determine a first security output associated with the first predetermined interior pressure change threshold.

As a further such example, embodiments described in this disclosure can utilize pressure data at a premises to determine a hazard remediation action to be taken. In some such embodiments, based on the pressure data detected at the premises (e.g., interior to the premises and/or exterior to the premises), a controller can take one or more actions to cause a hazard remediation action pertaining to the premises to be selected and output. For instance, when a change in pressure with the premises matches a first predetermined interior pressure change threshold, the controller can determine an action to be taken at a device at the premises to remediate the particular detected hazard condition.

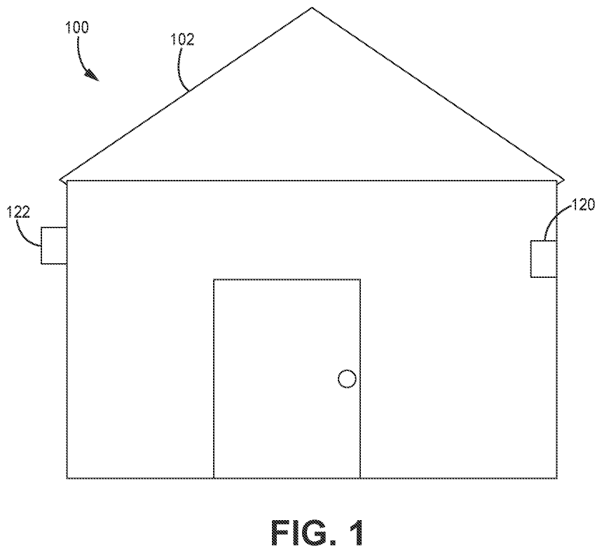

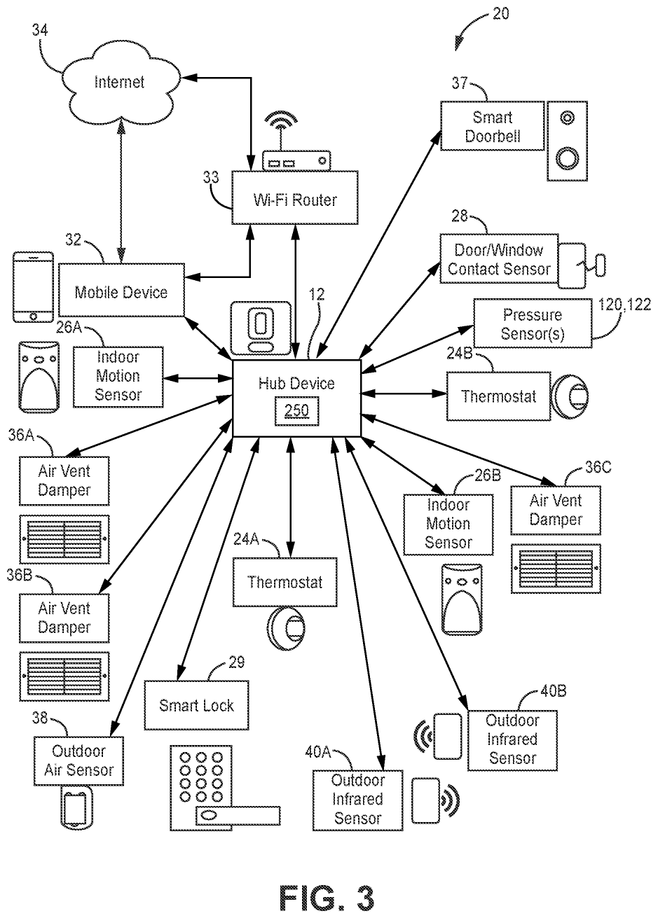

FIG. 1 is a conceptual block diagram illustrating an exemplary embodiment of a premises 102 with pressure sensors 120, 122. The pressure sensors 120, 122 can be included in a system 100 for using at least pressure data (e.g., a change in pressure data) to determine one or more characteristics at the premises 102 that can be used to determine one or more actions to be taken at the premises 102. Thus, the system 100 can be configured, at least in part, for use at the premises 102, which is typically a structure suitable to be inhabited by people, such as a home or an office. The interior pressure sensor 120 can be configured to measure pressure within the premises 102. In one or more examples, the interior pressure sensor 120 can be mounted on a wall, ceiling, or other suitable structure within the premises 102. In one or more examples, the interior pressure sensor 120 can be configured to be integrated with other control units of a home, such as a smart home or home automation system (e.g., such as the example shown at FIG. 3). For example, as described elsewhere herein, the interior pressure sensor 120 can be in communication with a controller and this controller can be in communication with one or more other premises devices, such as a heating, ventilation, and air conditioning (HVAC) system at the premises 102, a security system at the premises 102, other, non-pressure sensors (e.g., gas and/or fire sensor; glass break sensor; motion sensor; camera; door/window contact sensor) at the premises 102, and/or a door actuator (e.g., garage door actuator) at the premises 102. In some examples, the interior pressure sensor 120 can be incorporated with one or more of these other premises devices, such as a thermostat of the HVAC system. The exterior pressure sensor 122, when included, can be configured to measure pressure outside the premises 102.

In some examples, the pressure sensors 120, 122 can be relatively highly sensitive pressure sensors (sometimes referred to as “micro pressure sensors”) that are configured to measure as little as 1 cm of altitude change and detect pressure at a sensitivity of fractions of a Pascal (Pa) (e.g., tenths or hundredths of a Pa). In some examples, the pressure sensors 120, 122 can include sensors that have a noise floor of equal to or less than about 1 Pa, 0.5 Pa, 0.25 Pa, 0.1 Pa, or 0.01 Pa. In some examples the pressure sensor noise floor is less than 0.2 Pa, is the noise in the pressure measurements, for the condition where the sensor is free of external pressure changes, fluctuations, or pressure induced noise. The pressure sensors 120, 122 can be configured to periodically sample pressure measurements inside and/or outside of the premises 102 at preset intervals, such as at one second or one minute intervals.

The system 100 can include processing capabilities that are not explicitly shown in FIG. 1 and described elsewhere herein. These processing capabilities can, for example, be located within a device inside of premises 102 or may be remotely accessible, such as cloud accessible.

By periodically taking interior pressure measurements inside premises 102 using interior pressure sensor 120, system 100 can identify, based on these interior pressure measurements, interior pressure changes and/or an interior presence of one or more predetermined pressure signatures, overtime. System 100 can also identify exterior pressure changes and/or an exterior presence of one or more predetermined pressure signatures over time that occur outside of premises 102 using exterior pressure sensor 122. System 100, for instance at the controller, can then evaluate the interior pressure changes and/or the exterior pressure change, and/or evaluate the interior pressure data for the presence of one or more predetermined pressure signatures and/or evaluate the exterior pressure data for the presence of one or more predetermined pressure signatures, to determine an output associated the interior pressure changes and/or the exterior pressure changes.

As will be apparent from the present disclosure, the detected interior and/or exterior pressure changes and/or predetermined pressure signature can be used for a variety of various purposes, including each of the various applications disclosed herein. For example, the use of measured pressure data can be used to detect events at premises 102, such as security, hazard, and/or weather events at premises 102. For instance, the measured pressure data can be used to monitor for intrusions into premises 102, such as an open or broken window or open door (e.g., system 100 can be configured to identify in the pressure data one or more predetermined pressure signatures indicative of doors or windows being opened; system 100 can be configured to determine a presence of a person inside premises 102 based on detection of an open window/door, and some cases, one or more additional data points from one or more other sensors at premises 102, such as air quality from a gas and/or fire sensor; a glass break sensor; a motion sensor; a camera a door/window contact sensor).

Thus, one exemplary application can utilize one or more pressure sensors, such as interior pressure sensor 120 (e.g., a micro pressure sensor) and/or exterior pressure sensor 122 (e.g., a micro pressure sensor), to detect a current or anticipated event at premises 102, and, in some cases, cause an action associated with that detected current or anticipated event to be taken. Examples include taking (e.g., periodically) interior pressure measurements within the premises 102 using the interior pressure sensor 120, identifying, based on one or more of the interior pressure measurements, interior pressure changes and/or a presence in the interior pressure data of one or more predetermined pressure signatures over time, identifying external pressure changes and/or a presence in the exterior pressure data of one or more predetermined pressure signatures over time (e.g., based on one or more exterior pressure measurements outside the premises 102 using the exterior pressure sensor 122), evaluating the data sets for interior pressure changes and/or the external pressure changes and/or evaluating the pressure data sets for the presence of one or more predetermined pressure signatures, and generating an output in response to the evaluation. In some such examples, when the evaluation exceeds one or more predetermined statistical limits or agrees or matches one or more predetermined pressure signatures, an occurrence of an event can be indicated.

In one or more examples, the system 100 at the premises 102 can include a memory, and one or more processors implemented in circuitry and in communication with the memory, with the one or more processors configured to periodically take interior pressure measurements inside the premises 102 with the interior pressure sensor 120, identify, based on the interior pressure measurements, interior pressure changes over time, periodically take exterior pressure measurements outside the premises 102 with the exterior pressure sensor 122, identify external pressure changes over time, and evaluate the interior pressure changes and the external pressure changes using, at least in part, the system 100.

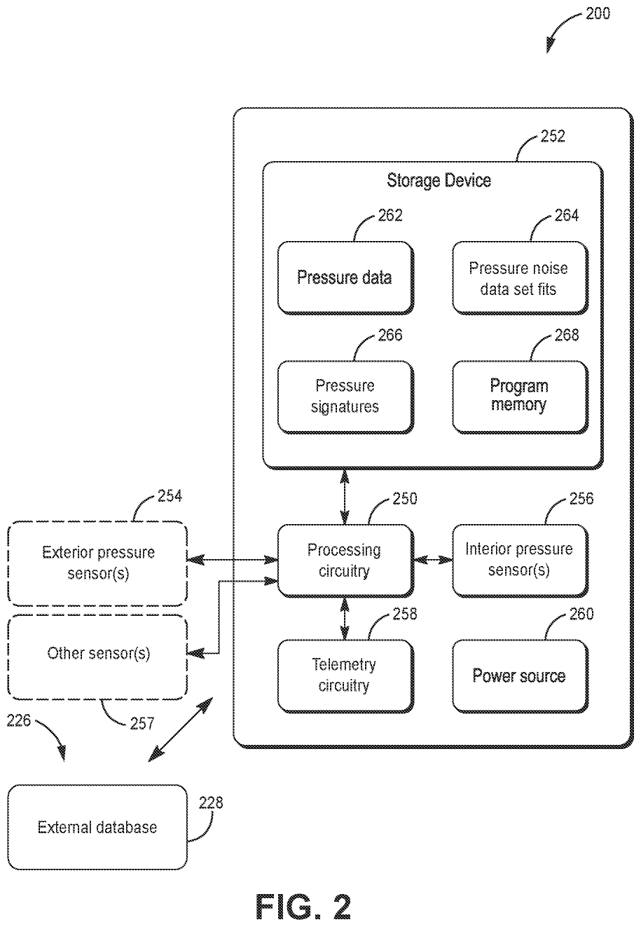

FIG. 2 is a block diagram illustrating an example configuration of components of a system 200, in accordance with one or more techniques of this disclosure. In some examples, system 200 can be configured for determining an occurrence of, or anticipated occurrence of, an event at premises 102, such as security, hazard, and/or weather events at premises 102. System 200 can be one example of system 100 of FIG. 1 for use, at least in part, at premises 102 of FIG. 1. System 200 can include telemetry circuitry 258, processing circuitry 250, storage device 252, exterior and interior pressure sensor(s) 254, 256, one or more other sensor(s) 257 (e.g., such as one or more of those shown at FIG. 3), and power source 260. Processing circuitry 250 may include one or more processors configured to perform various operations of system 200.

In the example shown in FIG. 2, storage device 252 may store pressure data obtained directly or indirectly from one or more pressure sensors, such as interior pressure sensor(s) 256 and/or, when so included in system 200, exterior pressure sensor(s) 254 and/or other sensor(s) 257. Storage device 252 may further store pressure data 262 and pressure noise data set fits 264 that provides a measure of the relationship between exterior pressure data and interior pressure data. The system 200 can process sensed pressure data by comparing, with the processing circuitry 250, interior pressure noise data set fits 264 with one or more predetermined pressure signatures 266, for example, to determine an occurrence, or an anticipated occurrence, of an event at the premises (e.g., the premises 102 of FIG. 1).

As noted, system 200 can process pressure data, from interior pressure sensor(s) 256 and/or exterior pressure sensor(s) 254, by comparing, with the processing circuitry 250, interior pressure noise data set fits 264 with one or more predetermined interior pressure signatures 266, for example, to determine an occurrence, or an anticipated occurrence, of an interior event at the premises (e.g., the premises 102 of FIG. 1) and/or by comparing, with the processing circuitry 250, exterior pressure noise data set fits 264 with one or more predetermined exterior pressure signatures 266, for example, to determine an occurrence, or an anticipated occurrence, of an exterior event at the premises. Storage device 252 can store one or more predetermined pressure signatures 266, such as a plurality of different predetermined pressure signatures, each corresponding to a different type of event at the premises. For example, storage device 252 can store a first predetermined pressure signature corresponding to a first type of security, hazard, and/or weather condition (e.g., a first type of security condition at the premises, such as the presence of an intruder) at the premises, a second predetermined pressure signature corresponding to a second type of security, hazard, and/or weather condition (e.g., a first type of hazard condition at the premises, such as the presence of a fire and/or gas) at the premises, and a third predetermined pressure signature corresponding to a third type of security, hazard, and/or weather condition (e.g., a first type of weather condition at the premises, such as weather conditions indicative of an anticipated sever storm, such as a tornado or hurricane) at the premises. Storage device 252 can also store a correspondence table which associates the different first, second, and third predetermined pressure signatures each with a particular type of security, hazard, and/or weather condition at the premises.

The system 200 can process received pressure data by comparing, with the processing circuitry 250, the received pressure data to the stored one or more predetermined pressure signatures 266, such as a plurality of different predetermined pressure signatures, each corresponding to a different type of event at the premises. And, when the processing circuitry 250 determines that the received pressure data matches one of the stored predetermined pressure signatures 266, processing circuitry can determine that the received pressure data is indicative of the particular type of event at the premises to which that matched predetermined pressure signature corresponds, for instance, using the stored correspondence table which associates the different predetermined pressure signatures each with a particular type of security, hazard, and/or weather condition at the premises.

A predetermined pressure signature can be representative of one or more characteristics of the received interior and/or exterior pressure data, such as one or more characteristics of the received pressure data that correspond to a particular type of security, hazard, and/or weather condition. For instance, a predetermined pressure signature can be representative of a characteristic of the received interior and/or exterior pressure data such as a pressure rate of change, pressure noise, and/or a pressure waveform, where the pressure rate of change, pressure noise, and/or a pressure waveform is indicative of a particular type of security, hazard, and/or weather condition at the premises.

As such, in one example, processing circuitry 250 can compare sensor pressure noise data set fits 264, derived from the received premises pressure data, against one or more predetermined pressure noise data signatures to determine whether the received premises pressure data matches a particular predetermined pressure noise data signature, and, thus, indicates the presence, or anticipated presence, of the particular security, hazard, and/or weather condition at the premises corresponding to that particular predetermined pressure noise data signature. For instance, this can include comparing sensor pressure noise set fits against a predetermined pressure signature which may be used to classify the data and determine the presence of the specific security, hazard, and/or weather condition at the premises. In some examples, the predetermined pressure signatures may include a degree of coupling that is processed according to a threshold to indicate the presence of the specific security, hazard, and/or weather condition at the premises. In some examples, the processing circuitry 250 evaluates noise calculation readings for the interior sensor readings and exterior sensor readings over time. The noise calculations for the interior and exterior sensor readings may be further evaluated to indicate a degree of coupling. Thus, the process can include evaluating the degree to which the pressure noise data set fit compares to one or more pressure signatures and satisfies a threshold. In some examples, the threshold may be composed of the magnitude of increase of the pressure noise data set fit above the nominal condition and the period of time for the increase. In another example, processing circuitry 250 can compare a pressure rate of change, derived from the received premises pressure data, against one or more predetermined pressure rate of change signatures to determine whether the received premises pressure data matches a particular predetermined pressure rate of change signature, and, thus, indicates the presence, or anticipated presence, of the particular security, hazard, and/or weather condition at the premises corresponding to that particular predetermined pressure rate of change signature. In yet another example, processing circuitry 250 can compare a pressure waveform, derived from the received premises pressure data, against one or more predetermined pressure waveform signatures to determine whether the received premises pressure data matches a particular predetermined pressure waveform signature, and, thus, indicates the presence, or anticipated presence, of the particular security, hazard, and/or weather condition at the premises corresponding to that particular predetermined pressure waveform signature.

In one or more examples, the system 200 does not store the sensed pressure data and instead sends or communicates the pressure data to a remote device. Telemetry circuitry 258 supports wireless communication between system 200 and a remote device such as another computing device that can receive data from the system 200. Processing circuitry 250 of system 200 may receive, updates to programs stored in program memory 268, pressure signatures 266, and algorithms via telemetry circuitry 258. Telemetry circuitry 258 in system 200, as well as telemetry circuits in other devices and systems described herein, may accomplish communication by radiofrequency (RF) communication techniques. Telemetry circuitry 258 may send information to a remote system on a continuous basis, at periodic intervals, or upon request from the remote system.

System 200 can communicate pressure data, pressure noise data set fits, alerts, or other information via wired or wireless connection for example, with an external database 228, for example, at an external computing device. The external computing device may be, include, or otherwise be used in combination with a mobile phone, smartphone, tablet computer, personal computer, desktop computer, personal digital assistant, router, modem, remote server or cloud computing device, and/or related device allowing system 200 to communicate over a communication network such as, for example, the Internet or other wired or wireless, such as cellular, connection. Communicating via the wired or wireless connection can allow system 200 to be configured, controlled, or otherwise exchange data with the external computing device. In some examples, system 200 communicating via wired or wireless connection may allow a user to set up system 200 when first installing the system 200 at premises 102. In some examples, system 200 and external computing device communicate through a wireless network device such as a router or a switch. In other examples, system 200 and external computing device communicate through a wired connection such as an ethernet port, USB connection, or other wired communication network.

System 200 can, via the communication device, communicate via a wired or wireless connection 226 with external database 228. In some examples, wired or wireless connection 226 enables system 200 to communicate with external database 228 via a wireless connection which includes a network device such as a router, ethernet port, or switch. System 200 and external database 228 may also communicate through a wired connection such as an ethernet port, USB connection, or other wired communication network. Communicating via the wired or wireless connection 226 may allow system 200 to exchange data with external database 228. As such, external database 228 may be at a location outside of building 102. In some examples, external database 228 may be, include, or otherwise be used in combination with a remote server, cloud computing device, or network of controllers configured to communicate with each other. For example, system 200 may check with other pressure sensor(s) controller(s) in nearby buildings through the internet or wide-area network. System 200 may include the onboard database because it is unable to communicate via the communication device.

In some examples, external database 228 may be, or otherwise be included in, or accessed via, external computing device (e.g., smartphone, mobile phone, tablet computer, personal computer, etc.). For example, system 200 may communicate via a Wi-Fi network connection with a smartphone device to exchange data with external database. By communicating via wired or wireless connection, system 200 may exchange data with external database.

Processing circuitry 250 may include one or more processors, such as any one or more of a microprocessor, a microcontroller, a digital signal processor (DSP), an application specific integrated circuit (ASIC), a field-programmable gate array (FPGA), discrete logic circuitry, or any other processing circuitry configured to provide the functions attributed to processing circuitry 250 herein may be embodied as firmware, hardware, software or any combination thereof.

In the illustrated example of FIG. 2, processing circuitry 250 may be configured to process pressure data information received from one or more pressure sensors, such as interior pressure sensor 256 and/or, when included, exterior pressure sensor 254, and/or, when so included, one or more other sensor(s) 257. In some examples, the processing of pressure data information occurs in a device other than processing circuitry 250 of system 200, such as a processor remote from system 200. Processing circuitry 250 receives information regarding the pressure data, such as information relating to sensed pressures associated with an interior location of the premises, and/or information relating to pressures associated with an exterior location of the premises. In some examples, processing circuitry 250 may receive external pressure data from a source other than an exterior pressure sensor 254. For example, processing circuitry 250 may receive exterior data from an external source, such as weather stations, or cloud shared data from other regional sensors.

Storage device 252 may be configured to store information within system 200 during operation. Storage device 252 may include a computer-readable storage medium or computer-readable storage device. In some examples, storage device 252 includes one or more of a short-term memory or a long-term memory. Storage device 252 may include one or more of the following, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, storage device 252 is used to store data indicative of instructions, e.g., for execution by processing circuitry 250. As discussed above, storage device 252 may be configured to store pressure data 262 and/or pressure noise data set fits 264, and, in some embodiments, other non-pressure data pertaining to the premises.

Power source 260 is configured to deliver operating power to the components of system 200. Power source 260 may include a battery and a power generation circuit to produce the operating power. In some examples, the battery is rechargeable to allow extended operation. Power source 260 may include any one or more of a plurality of different battery types, such as nickel cadmium batteries and lithium ion batteries.

In some examples, processing circuitry may direct the sensors 254, 256 to sense pressures, at preset times and/or in response to preset events. In one or more examples, the processing circuitry 250 of the system 200 may command sampling rates of the interior pressure sensor 256 and/or the exterior pressure sensor 254. For example, processing circuitry 250 may direct the interior pressure sensor to periodically take interior pressure measurements. In some examples, the processing circuitry 250 may direct the exterior sensor 254 to periodically take exterior pressure measurements, for example over a preset time. In one or more examples, taking interior pressure sensor measurements and/or taking exterior pressure sensor measurements occurs at one-tenth of a second intervals, one second intervals, five second intervals, ten second intervals, sixty second intervals, two minute intervals, fifteen minute intervals, thirty minute intervals, or one hour intervals.

The processing circuitry 250 may use the interior pressure measurements to identify interior pressure changes over time. The processing circuitry 250 may further identify external pressure changes over time outside of the premises. And, in some embodiments, processing circuitry 250 can acquire non-pressure data relating to the premises over the same period of time as the interior and/or exterior pressure data.

In some examples, the processing circuitry 250 is configured to evaluate a difference, such as one or more differences, between the interior pressure changes and the external pressure changes. In one or more examples, the processing circuitry 250 is configured to evaluate the interior pressure changes and the exterior pressure changes. In some examples, the processing circuitry 250 is configured to use the pressure changes to determine the occurrence of a security, hazard, and/or weather event at the premises.

In some examples, processing circuitry 250 processes the pressure data. For example, processing circuitry may calculate the root mean square (RMS) pressure fluctuation noise power (RMS pressure noise) of two or more consecutive samples to obtain the noise power in the interior and exterior pressure data. In some examples, processing circuitry further calculates an average over time of the RMS pressure noise data. In one or more examples, a pressure sensor sampling frequency of one sample per second sets the Nyquist frequency, for example at 0.5 Hz. In some examples, the number of consecutive samples may be controlled for noise calculations, and in some examples a lower frequency for the noise integral may also be controlled.

In one or more examples, a sampling transfer function may occur. In some examples, an upper Nyquist frequency may be set to capture pressure variations from, for example, wind and breeze fluctuations. In some examples, the Nyquist frequency may be set at 0.5 Hz. In one or more examples, a lower sampling frequency may be set to reject low frequency weather and/or atmospheric pressure changes. In some examples, the lower frequency roll off may be set to reject below 0.05 Hz. In some examples, the lower frequency may be set to reject below 0.2 Hz. In some examples, the lower frequency may be set to reject below 0.1 Hz. In some examples, the lower frequency may be set to reject below 0.05 Hz. In some examples, the lower frequency may be set to reject below 0.033 Hz. In some examples, the lower frequency may be set to reject below 0.025 Hz. In some examples, the lower frequency may be set to reject below 0.02 Hz. In some examples, the lower frequency may be set to reject below 0.01 Hz.

In some examples, processing circuitry may direct the sensors 254, 256 to sense pressures, at certain times or in response to certain events. In one or more examples, the processing circuitry 250 of the system 200 may direct sampling rates of the interior pressure sensor 256 and/or the exterior pressure sensor 254. For example, processing circuitry 250 may direct the interior pressure sensor to periodically take interior pressure measurements at preset intervals, such as any of those preset intervals previously noted. And, the processing circuitry 250 may use the interior pressure measurements to identify interior pressure changes over time. In some examples, the processing circuitry 250 may further identify external pressure changes over time, where the external pressure changes are outside of the building structure.

FIG. 3 is a block diagram illustrating an example of a premises network 20, in accordance with one or more techniques described herein. System 100 at premises 102 can, in some embodiments, include a network such as the premises network 20. Various devices, including various types of sensor devices, can be deployed in the network 20. For example, in the network 20, various devices, including various sensor devices, can be in communication with a hub device 12, which can include processing circuitry 250 as described elsewhere herein. Hub device 12 can, in some embodiments, thus function as the controller described elsewhere herein. In some embodiments, these devices in the network 20 can be in data communication (e.g., two-way data communication) with the hub device 12. Network 20 may be installed within a building and the surrounding premises (collectively, “premise”).

Hub device 12 may include a computing device configured to operate one or more systems within a building, such as HVAC/comfort, security, safety, and/or home automation systems. For example, as described further below in reference to FIG. 2, hub device 12 can include processing circuitry 250 configured to receive data (e.g., pressure data from interior and/or exterior pressure sensor 120, 122), such as data received from one or more sensor devices and/or from user input, and process the data in order to automate one or more systems within a building. For example, hub device 12 may automate, control, or otherwise manage systems including heating and cooling, ventilation, illumination, alarm, or authorized access to individual rooms or other regions, as non-limiting examples. For example, hub device 12 may include a “Life and Property Safety Hub®” of Resideo Technologies, Inc.®, of Austin, Texas. Hub device 12 may include a wired connection to an electric power grid, but in some examples may include an internal power source, such as a battery, supercapacitor, or another internal power source.

Devices on the network 20, including sensor devices, can be configured to collect or generate sensor data and transmit the sensor data to hub device 12 for processing. In some examples, sensor devices can include a controllable device. A controllable device may be configured to perform a specified function when the controllable device receives instructions (e.g., a command or other programming) to perform the function from hub device 12. Examples of different types of sensor devices that can be included in the network 20 are described below. Sensor devices can include either a wired connection to an electric power grid or an internal power source, such as a battery, supercapacitor, or another internal power source. Although FIG. 1 shows hub device 12 as directly connected to the various devices in the network 20, in some examples, network 20 can include one or more repeater nodes that are each configured to act as an intermediary or “repeater” device.

As shown for the illustrated embodiment of the network 20 at FIG. 1, in addition to the hub device 12, the network system 20 can include various devices, including various types of sensor device. Exemplary types of sensor devices that can deployed in the network system include thermostats 24A, 24B (collectively, thermostats 24), indoor motion sensor 26A and outdoor motion sensor 26B (collectively, motion sensors 26), door/window contact sensor 28, air vent damper 36A, 36B, 36C (collectively, air vent dampers 36), smart doorbell 37, outdoor air sensor 38, outdoor infrared sensor 40A, indoor infrared sensor 40B (collectively, infrared sensors 40), interior pressure sensor 120, and/or exterior pressure sensor 122. In addition to the sensor devices, the network system can include devices such as router 33 and mobile device 32.

Hub device 12 can be in wireless data communication with thermostats 24, motion sensors 26, door/window contact sensor 28, air vent dampers 36, smart doorbell 37, outdoor air sensor 38, infrared sensors 40, and pressure sensors 120, 122. Each of thermostats 24, motion sensors 26, door/window contact sensor 28, air vent dampers 36, smart doorbell 37, outdoor air sensor 38, infrared sensors 40, and pressure sensors 120, 122 can include either a sensor device (e.g., a device configured to collect and/or generate sensor data), a controllable device, or both, as described herein. For example, thermostats 24 may include comfort devices having sensors, such as a temperature sensor configured to measure an ambient air temperature, a humidity sensor configured to measure an ambient moisture content, and/or an air quality sensor configured to measure a quality of air (e.g., presence of contaminates in the ambient air). In some examples, air vent dampers 36 may include devices located within an air vent or air duct, configured to adjust a volume of air flow through an air duct in response to receiving instructions from hub device 12.

Thermostats 24 may be configured to wirelessly transmit the temperature, humidity, and/or air quality (e.g., sensor data) directly to hub device 12. Additionally, thermostats 24 may include controllable devices, in that they may activate or deactivate a heating, cooling, or ventilation system in response to receiving instructions from hub device 12. For example, thermostat 24A may collect temperature data and transmit the data to hub device 12. Hub device 12, in response to receiving the temperature data, may determine that a respective room is either too hot or too cold based on the temperature data, and transmit a command to thermostat 24A to activate a heating or cooling system as appropriate. In this example, each of thermostats 24 may include both sensor devices and controllable devices within a single distinct unit.

Indoor and outdoor motion sensors 26 may include security devices configured to detect the presence of a nearby mobile object based on detecting a signal, such as an electromagnetic signal, an acoustic signal, a magnetic signal, a vibration, or other signal. The detected signal may or may not be a reflection of a signal transmitted by the same device. In response to detecting the respective signal, motion sensors 26 may generate sensor data indicating the presence of an object, and wirelessly transmit the sensor data to hub device 12. Hub device 12 may be configured to perform an action in response to receiving the sensor data, such as outputting an alert, such as a notification to mobile device 32, or by outputting a command for the respective motion sensor 26 to output an audible or visual alert. In this example, each of motion sensors 26 may include both sensor devices and controllable devices within a single unit.

Door and/or window contact sensor 28 may include a security device configured to detect the opening of a door or window on which the door and/or window contact sensor 28 is installed. For example, contact sensor 28 may include a first component installed on a door or window, and a second component installed on a frame of the respective door or window. When the first component moves toward, past, or away from the second component, the contact sensor 28 may be configured to generate sensor data indicating the motion of the door or window, and wirelessly transmit the sensor data to hub device 12. In response to receiving the sensor data, hub device may be configured to perform an action such as outputting an alert, such as a notification to remote user device (e.g., mobile device 32), or by outputting a command for the respective contact sensor 28 to output an audible or visual alert. In this example, contact sensor 28 may include sensor devices and a controllable devices within a single unit.

Air vent dampers 36 may be configured to regulate a flow of air inside of a duct. For example, thermostats 24 may generate a control signal to adjust a positioning of damper 36A relative to the air duct it is located at (e.g., when the room is not occupied). In this example, in response to the control signal, damper 36A may close to prevent air from flowing from air vent damper 36A. In some examples, air vent dampers 36 may send sensor data indicating a state (e.g., open or closed) of the respective air vent damper. For instance, air vent damper 36 may output, to thermostats 24 an indication that air vent damper 36 is in an open state.

Smart doorbell 37 may be configured to provide notifications to hub device 12. For example, smart doorbell 37 may be configured to provide a notification (e.g., message) when a button (e.g., doorbell) of smart doorbell 37 is activated. In some examples, smart doorbell 37 may include motion sensor circuitry configured to generate a notification in response to motion detected near smart doorbell 37. In some examples, smart doorbell 37 may be configured to generate video content in response to motion detected near smart doorbell 37. In some examples, smart doorbell 37 may be configured to generate audio content in response to motion detected near smart doorbell 37. For instance, in response to motion detected near smart doorbell 37, smart doorbell 37 may generate video content using a camera and/or audio content using a microphone. In this instance, smart doorbell 37 may output the video content and audio content to hub device 12, which may forward the video content and/or audio content to mobile device 32.

Outdoor air sensor 38 may be configured to generate sensor data indicating, for example, a temperature, humidity, pressure, and/or air quality (e.g., carbon monoxide, particulate matter, or other hazards) of the surrounding air. In some examples, outdoor air sensor 38 may wirelessly transmit the sensor data to hub device 12. For instance, outdoor air sensor 38 may periodically output a current or average temperature to thermostats 24 via hub device 12.

Outdoor passive infrared sensors 40 may include security devices configured to detect the presence of a nearby object, such as a person, based on detecting infrared wavelength electromagnetic waves emitted by the object. In response to detecting the infrared waves, passive infrared sensors 40 may generate sensor data indicating the presence of the object, and wirelessly transmit the sensor data to hub device 12. Hub device 12 may be configured to perform an action in response to receiving the sensor data, such as outputting an alert, such as a notification to mobile device 32, or by outputting a command for the respective passive infrared sensor 40 to output an audible or visual alert.

Network 20 may include various devices, including, for example, a security device, a water heater, a water flow controller, a garage door actuator, or other devices. For example, network 20 may include one or more of: a door contact sensor, a motion passive infrared (PIR) sensor, a min contact sensor, a key fob, a smoke detector, a glass break detector, a siren, a combined smoke detector and Carbon monoxide (CO) detector, an indoor siren, a flood sensor, a shock sensor, an outdoor siren, a CO detector, a wearable medical pendant, a wearable panic device, an occupancy sensor, a keypad, and/or other devices.

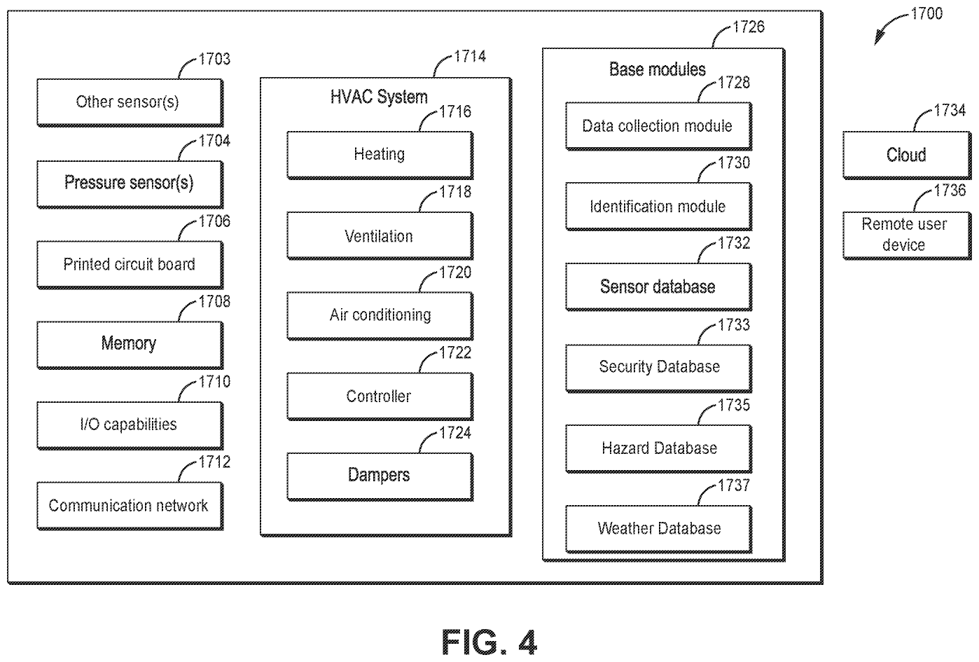

FIG. 4 a block diagram illustrating an example system 1700 for determining a change in pressure and causing an output associated with at least the change in pressure, in accordance with one or more techniques described herein. For example, the system 1700 can be used to execute any one or more of the processes and techniques described elsewhere herein. In one particular application, the system 1700 can be configured to provide detection and notification of a security, hazard, or weather event, or anticipated event, at the premises (e.g., at a specified zone within the premises). For instance, the system 1700 can detect an interior area of a premises with a security, hazard, or weather event, or anticipated event, based on interior and/or exterior premises pressure data and determine an output associated with that interior and/or exterior premises pressure data corresponding to the particular event. As one example, system 1700 can determine an adjustment to at least one HVAC system setting (e.g., in an automated manner) to reduce or eliminate effects of the security, hazard, or weather event and/or output a notification relating to the security, hazard, or weather event. Also, in some additional instances, the system 1700 can use interior and/or exterior premises pressure data to determine one or more air flow patterns within the premises and cause an adjustment to such one or more air flow patterns based on the security, hazard, or weather event determined based on the change in pressure.

The system 1700 can include one or more non-pressure sensors 1703 (e.g., one or more non-pressure sensors shown at the exemplary network of FIG. 3), one or more pressure sensors 1704 at a premise (e.g., at least one interior pressure sensor, at least one interior pressure sensor and at least one exterior pressure sensor), programmable processing circuitry 1706, input/output capabilities 1708, communication network (wired or wireless) 1712, HVAC system 1714, base module 1726, remote server (“cloud”) 1734, and remote user device (e.g., mobile computing device) 1736. HVAC system 1714 can include one or more components described elsewhere herein with respect to HVAC systems, such as heating component 1716, ventilation component 1718, air condition component 1720, controller 1722, and one or more dampers 1724 (e.g., positioned at an air duct, such as an inlet and/or outlet of an air duct). Base module 1726 can include data collection module 1728, identification module 1730, and sensor database 1732. The system 1700 can be configured to utilize communication network 1712 to facilitate communication (e.g., data communication, command signals, etc.) between any two or more components of the system 1700, for instance to communicate sensed pressure data from one or more pressure sensors 1704 to controller 1722, base module 1726, cloud 1724, and/or remote user device 1736.

In one exemplary application, system 1700 can be configured to detect a security, hazard, or weather event, or anticipated event. To do so, for example, data collection module 1728 can receive premise pressure data from one or more pressure sensors 1704 (e.g., pressure data from at least one interior pressure sensor and pressure data from at least one exterior pressure sensor). Sensor database 1732 can store this received premise pressure data, and identification module 1730 can use the stored premise pressure data to determine an occurrence of a security, hazard, or weather event at the premises (e.g., using a comparison to one or more previously determined pressure changes, such as air flow patterns derived from such previously determined pressure changes; using any one of more of the techniques described herein previously). Further, in some cases, identification module 1730 can identify an area, or zone, within the premises at which the security or hazard event is present or is anticipated to be impacted by the security, hazard of weather event (e.g., using a previously populated and stored database identifying pressure sensors and corresponding premise locations). The system 1700 can determine an output based on at least the determined pressure change indicative of the security, hazard, or weather event (e.g., to the remote user device 1736 through the cloud 1734 connecting the base module 1726 to the remote user device 1736 via the communication network 1712). The system 1700 (e.g., the identification module 1730) can use the stored premise pressure data to provide an input command to a premises device, such as the HVAC system 1714 to take one or more HVAC-system related actions (e.g., adjust one or more dampers to reduce or increase airflow through that damper; actuation ventilation component to introduce air from outside the premises; etc.) to reduce or eliminate an impact of the security, hazard, or weather event.

As noted, system 1700, via data collection module 1728, can collect pressure sensor data from pressure sensors 1704 located at the exterior of the premise and the interior of the premise. In some further examples, system 1700, via data collection module 1728, can additionally collect other data, such as humidity, temperature, and/or air quality (e.g., inside and/or outside the premise) as well as, in some embodiments, other data such as from one or more devices shown in the network at FIG. 3. The collected sensor data, including at least the premise pressure data, can be stored in sensor database 1732. Then, as described previously, identification module 1730 can determine an occurrence, or anticipated occurrence, of a security, hazard, or weather event (e.g., including determining one or more airflow pattern inside the premise) using at least the pressure sensor data stored in sensor database 1732.

In operation, for detecting an occurrence, or anticipated occurrence, of a security, hazard, or weather event, system 1700 can begin with data collection module 1728 collecting sensor data, such as humidity, pressure, temperature, and/or air quality from pressure sensors 1704 located on the exterior and the interior of the premise and stores the sensor data for each sensor, along with each sensor's location at the premise, at sensor database 1732. Then identification module 1730 can determine a change in pressure and/or an airflow pattern at the premises, or zone of a premises, using the sensor data stored in sensor database 1732. As one specific illustrative example of system 1700 operation, system 1700 can include a security database 1733 that stores various predetermined pressure signatures and/or predetermined pressure thresholds, such as various predetermined pressure change thresholds (e.g., each of various predetermined interior pressure change thresholds and various predetermined exterior pressure change thresholds) each corresponding to one or more security outputs. Data collection module 1728 can receive pressure data from pressure sensors (e.g., interior and/or exterior pressure sensors) 1704 and, in some cases, additional data from temperature, humidity, air quality, security, and/or gas and/or fire sensors. Such collected data can be compared to various signatures and/or thresholds for the respective type of data, and if the receive data matches the respective one or more signatures and/or thresholds, the security database 1733 determines and extracts a corresponding security output.

As one example of the operation of system 1700 to detect an occurrence, or anticipated occurrence, of a security, hazard, or weather event and determine a corresponding output, if a door or window is opened that was previously closed, there would be a pressure change detected in the pressure data and could indicate that someone has entered the premises or a window has been opened. For example, if an interior pressure sensor in a kitchen zone within the premises detects pressure data matching a specific pressure signature and/or a change in the pressure of more than a predetermined pressure change threshold (e.g., more than 8 Pa, more than 1 Pa, more than 0.5 PA, more than 0.1 Pa) at 2:00 am, then it may determine that a window has been opened late at night, indicating a potential breach into the premises and a corresponding security output can be determined. As another example of the operation of system 1700 to detect an occurrence, or anticipated occurrence, of a security, hazard, or weather event and determine a corresponding output, if a person enters the premises and moves within the premises, there would be a pressure change detected in the pressure data (e.g., relative to sensed pressure data when such a person is not present and is not moving around) and could indicate that someone has entered the premises and is moving around within the premises (e.g., within a specific zone within the premises). Likewise, if an interior pressure sensor is positioned at a premises zone without a direct premises entry point (e.g., without a door or window, such as a hallway or staircase), and if pressure data from this interior pressure sensor indicates a match with a specific pressure signature and/or a pressure change matching a predetermined pressure change threshold, it can be determined that an intruder has moved within the premises into this zone lacking a direct entry point and experiencing the pressure change. The corresponding security output can be determined by ascertaining which output(s) in the security database 1733 correspond to the predetermined pressure signature and/or predetermined pressure change threshold matched by the interior pressure sensor in the kitchen zone. The determined security outputs in the security database 1733 can depend on the type of event the pressure data indicates to have occurred or be anticipated to occur, and can include, for instance, a notification to a remote device, an entry alert to a remote device, activation of an alarm condition at the premises (e.g., notification to a third party monitoring station). In some embodiments, one or more security sensors, such as one or more of those shown for the network of FIG. 3, can be actuated as a result of determining that the pressure change matches a specific pressure signature and/or predetermined pressure change threshold as a way to collect additional data as to the security event (e.g., to verify the occurrence of the security event to reduce instances of false alarms).

Thus, system embodiments can include a controller and at least a first pressure sensor. The first pressure sensor can be configured to detect a first air pressure within a premises at a first time and a second air pressure within the premises at a second, different time, and the first pressure sensor can be in communication with the controller. The controller can be configured to receive the first air pressure and the second air pressure within the premises from the first pressure sensor, determine a change in pressure within the premises using at least the first air pressure and the second air pressure, compare the change in pressure within the premises to a first pressure signature and/or a first predetermined interior pressure change threshold, and, when the change in pressure within the premises matches the first pressure signature and/or first predetermined interior pressure change threshold, determine a first output associated with the first predetermined pressure signature and/or first predetermined interior pressure change threshold. As one example noted above, the first predetermined pressure signature and/or first predetermined interior pressure change threshold can correspond to opening of a door or window, and the first output determined by the controller as associated with the first predetermined pressure signature and/or first predetermined interior pressure change threshold can be an entry alert to a remote device (e.g., a remote user device, such as a user's mobile device).

In further such examples of system 1700, the controller can use multiple, different predetermined interior pressure signatures and/or pressure change thresholds each corresponding to a different type of security, hazard, or weather event or anticipated event. As such, the controller can also be configured to compare the change in pressure within the premises to a second predetermined pressure signature and/or a second predetermined interior pressure change threshold that is different than the respective first predetermined pressure signature and/or first predetermined interior pressure change threshold, and, when the change in pressure within the premises matches the second predetermined pressure signature and/or second predetermined interior pressure change threshold, determine a second output associated with the second predetermined pressure signature and/or second predetermined interior pressure change threshold. For instance, the second predetermined pressure signature and/or second predetermined interior pressure change threshold can correspond to a presence of a person at the premises, and the second output determined by the controller as associated with the second predetermined pressure signature and/or second predetermined interior pressure change threshold can be an intruder alert to the remote device.

In yet further such examples, system 1700 can include other sensor(s) 1703, such as one or more types of security sensors (e.g., gas and/or fire sensor; glass break sensor; motion sensor; camera; door/window contact sensor; other sensor shown at the network of FIG. 3). The one or more security sensors can be in communication with the controller. And, the controller can further be configured to receive security data at the premises from the security sensor and, when both the change in pressure within the premises matches the first predetermined pressure signature and/or first predetermined interior pressure change threshold and the security data matches a first predetermined premises security threshold, determine a first output associated with each of the first predetermined pressure signature and/or first predetermined interior pressure change threshold and the first predetermined premises security threshold. The use of additional, non-pressure data from one or more other, security-type sensors can be helpful in instances where additional data, for instance for further event verification, is desirable.

Devices, systems, and techniques disclosed herein can, in addition to or as an alternative to those security examples disclosed herein, utilize pressure data at a premises to manage air flow within the premises, or cause other action(s) at the premises, in a manner related to a determined hazard or weather event, as will be described as follows.

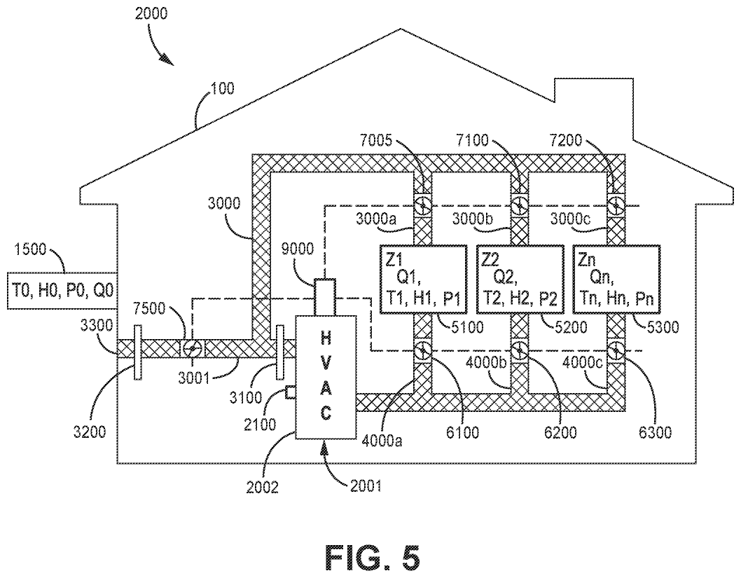

FIG. 5 is a block diagram illustrating an example of premises 100 that includes a system 2000. System 2000 includes one or more pressure sensors P0, P1, P2, Pn and a HVAC system 2001. System 2000 can, in some example, further include other sensor(s) 1703, such as one or more types of security sensors (e.g., gas and/or fire sensor; glass break sensor; motion sensor; camera; door/window contact sensor; other sensor shown at the network of FIG. 3).

System 2000 can utilize pressure data from the one or more pressure sensors P0, P1, P2, Pn to determine one or more outputs, which can, in some examples, include control actions to be taken at the HVAC system 2001. In the illustrated example, the pressure sensors P1, P2, Pn are interior pressure sensors located within the premises 100 and configured to sense pressure inside the premises 100, and the pressure sensor P0 is an exterior pressure sensor located outside the premises 100 and configured to sense pressure outside of the premises 100. The HVAC system 2001 can include a HVAC unit 2002 and one or more dampers, such as any one or more of dampers 6100, 6200, 6300, 7005, 7100, 7200, 7500. The HVAC unit 2002 can include a fan/blower, a heating component, a ventilation component, an air conditioning component to provide selectively conditioned air to the premises 100.

Source air, or return air, 3000 passes through a filter 3100 positioned upstream of an air inlet to the HVAC unit 2002. The source, or return, air 3000 passes through the filter 3100 and enters the HVAC unit 2002. In the illustrated embodiment, the premises 100 includes multiple, different zones spaced apart within the premises 100. These zones are shown here as Z1, Z2, and Zn, and each zone Z1, Z2, Zn receives air from the HVAC unit 2002 via an air duct 4000. In particular, zone Z1 receives air from the HVAC unit 2002 via air duct 4000 at duct outlet 5100, zone Z2 receives air from the HVAC unit 2002 via air duct 4000 at duct outlet 5200, and zone Zn receives air from the HVAC unit 2002 via air duct 4000 at duct outlet 5300. These zones may be discrete rooms or defined spaces within the premises 100, and while the exemplary illustration uses boxes to define these zones, these zones may be rooms that adjoin exterior walls or may be interior spaces or even an arbitrarily defined area without a wall or number of walls. Conditioned air from the HVAC unit 2002 is routed to zones, Z1-Zn, through duct 4000. A temperature sensor T1 can be located in zone Z1, and/or a temperature sensor T2 can be located in zone Z2, and/or a temperature sensor Tn can be located in zone Zn, and/or a temperature sensor TO can be located outside of premises 100 to provide temperature data signals to a controller 2100, and the controller 2100 can use the data to cause one or more control actions to be taken at the HVAC system 2001 (e.g., at the HVAC unit 2002, at a damper, etc.). The controller 2100 can use this temperature data to inform whether to introduce heated or cooled air into any of the zones Z1-Zn. Temperature sensors TO-Tn may be wired to controller 2100 and or may communicate wirelessly with controller 2100. The same can apply for other sensors of the HVAC system 2001, such as humidity sensors H0, H1, H2, Hn and pressure sensors P0, P1, P2, Pn. Air within the premises 100 can be recycled as return air via return air duct 3000, passing through filter 3100, then conditioned at HVAC unit 2002, and then provided to any one or more of zones Z1, Z2, Zn by way of the supply duct 4000.

HVAC system 2001 is shown to include dampers 6100, 6200, 6300, at supply air duct 4000, configured to control conditioned air flow from HVAC unit 2002 to zones Z1, Z2, Zn of premises 100. As shown here, damper 6100 corresponds to zone Z1 and is illustrated as positioned at supply air duct 4000a that supplies air to zone Z1, damper 6200 corresponds to zone Z2 and is illustrated as positioned at supply air duct 4000b that supplies air to zone Z2, and damper 6300 corresponds to zone Zn and is illustrated as positioned at supply air duct 4000n that supplies air to zone Zn. Dampers 6100, 6200, 6300 can be actuated, for example, by an applied voltage to control mechanical actuators integral to the dampers 6100, 6200, 6300.

In operation, temperature sensors T1, T2, Tn located, respectively, at zones Z1, Z2, Zn can provide respective zone temperature data to controller 2100. Controller 2100 can transmit an actuation command to one or more of dampers 6100,6200, 6300 either directly or by way of damper interface module controller 9000. For example, if zone Z1 has a temperature below a setpoint threshold (e.g., previously input at controller 2100), but zones Z2 and Zn are at or above the setpoint threshold, HVAC unit 2002 can respond by supplying heat, with damper 6100 commanded to open, for zone Z1 while dampers 6200 and 6300 for respective zones Z2, Zn commanded closed. In this way, heat can be targeted to the zone, here Z1. As HVAC unit 2002 can also supply cooling, zone dampers 6100, 6200, 6300 can be actuated to direct cooling to zones that are above the temperature setpoint threshold. Similar operation can be performed for conditioned humified air or dehumidified air in response to humidity sensors H1-Hn located in zones Z1-Zn.

As noted, system 2000 can include exterior sensors 1500 located outside of premises 100. Exterior sensors 1500 can include exterior temperature sensor TO, exterior humidity sensor H0, exterior pressure sensor P0, and/or exterior air quality sensor Q0. One or more additional exterior sensors 1500 can also be included, for instance such as one or more of the noted security type sensors. As return air 3000 is taken from within premises 100, and conditioned air is supplied inside premises 100, there may be a pressure offset or difference between the interior pressure measured by one or more of pressure sensors P1-Pn and the exterior pressure measured by pressure sensor P0. This can result from environmental factors such as outside and inside temperature, any wind breeze present, and/or an amount of structural air leakage area that exists at premises 100.

In one example, system 2000 can be configured to induce an increase in air pressure within the premise 100 (e.g., to thereby reduce outside air infiltration into the premises, such as in the event of a hazardous condition, such as a fire or poor air quality, outside of the premises). As will be discussed further, dampers 6100, 6200, 6300, 7005, 7100, 7200, 7500, can be dampers that are configured to not only actuate to fully open and fully closed positions but can also be configured to be actuated to incremental positions between fully open and fully closed so as to facilitate more precise air volume conveyance capability (e.g., which can be useful where pressure sensors are utilized in the system 2000 as described herein). With respect to the dampers 7005, 7100, 7200, 7500 specifically, their configuration to actuate to incremental positions between fully open and fully closed can allow for incrementally adjusting the amount of inside air, via the dampers 7005, 7100, 7200, and outside air, via the damper 7500, that is blended into the return air input to the HVAC unit 2002. For example, the less constrained the outside air 3300 flow is through damper 7500 compared to the inside air flow through damper 7005, 7100, and/or 7200, the more outside air that is included in the return air input to the HVAC unit 2002, and, conversely, the less constrained the inside return air flow is through damper 7005, 7100, and/or 7200 is compared to the outside air flow through damper 7500, the more inside return air that is included in the return air input to the HVAC unit 2002. The more outside air 3300 that is introduced into the premise 100 (e.g., via actuation of damper 7500), the greater the pressure increase that is induced within premise 100 as compared to the pressure outside pressure 100. Accordingly, controlling the amount of flow restriction at dampers in coordination can thereby allow for control of the mix of inside and outside return air and, thus, the amount of pressure change that is induced within premise 100 relative to the pressure outside of premise 100.

In more specific such instances, pressure can be controlled and adjusted at individual interior zones, Z1, Z2, Zn using, respectively, dampers 6100, 6200, 6300. As described for dampers 7005, 7100, 7200, 7500, dampers 6100, 6200, 6300 can be configured to adjust to various incremental positions between fully opened and fully closed states. Opening one of the interior zone associated dampers, for example damper 6100, while restricting air flow through other interior zone dampers, for example dampers 6200 and 6300, can cause an additional pressure to develop in, and thus induce an increase in pressure at, the zone corresponding to opened damper 6100, in this example zone Z1. While the control of return air source dampers 7005, 7100, 7200, 7500, affects the relative pressure inside premise 100 to outside premise 100, control of the zone associated dampers 6100, 6200, 6300 affects the relative pressures P1, P2, Pn between the associated interior zones Z1, Z2, Zn. If the interior pressure at premises 100 is greater than the outside pressure, outside air infiltration into premises 100 will be minimized. Accordingly, this more precise, zone control can be useful, for instance, at times when a hazardous event (e.g., fire) is present outside the premises can induce input exterior air to come from filtered air source 3300 while displacing unfiltered infiltration air because of the controlled increase in the internal pressure at premises 100. Supplying this filtered air source 3300 selectively to one or more of zones Z1, Z2, Zn allows controller 2100 to adjust interior pressure to a targeted inside-to-outside pressure differential and also to adjust interior zone associated pressure to a targeted interior zone-to-zone pressure differential. And, this targeted interior zone-to-zone pressure differential can be caused using the HVAC system 2001 when a change in pressure data is determined to match a corresponding predetermined pressure signature and/or predetermined pressure change threshold (e.g., indicating the occurrence of a hazardous event or weather event inside or outside the premises).

As noted, dampers 7005, 7100, 7200 are included at inside return air source duct 3000. In particular, damper 7005 is included at return air source duct 3000a associated with zone Z1 return air, damper 7100 is included at return air source duct 3000b associated with zone Z2 return air, and damper 7200 is included at return air source duct 3000c associated with zone Zn return air. Controlling the state, including particular degree of air restriction positioning, of one or more of dampers 7005, 7100, 7200 can facilitate enhanced control of the relative pressures between zones Z1, Z2, Zn. For example, having each of supply dampers 6200, 6300 in an opened position and having each of return air dampers 7100, 7200 in a closed position, while having supply damper 6100 in a closed position and return air damper 7005 in an opened position can cause a relative pressure increase in each of zones Z2, Zn while causing a relative pressure decrease in zone Z1. This can more precisely control relative pressures between inside and outside premises 100 by allowing for pressure adjustment control of one or more specific zone pressure inside premises 100 with respect to pressure outside premises 100. Additionally, this can provide the ability to control relative pressure between interior zones Z1, Z2, Zn to facilitate environmental balancing between such interior zones. For example, if an interior premises hazardous event (e.g., fire) is determined as a result of interior pressure change data matching a predetermined pressure signature and/or a predetermined interior pressure change threshold, the controller 2100 can cause the HVAC system 2001, via the relative, coordinated damper air volume adjustment, to reduce a volume of air supplied to a zone at which the interior premises hazardous event (e.g., fire) is determined as a result of interior pressure change data matching the predetermined pressure signature and/or predetermined interior pressure change threshold.

The techniques described herein can be performed to achieve a variety of desired outcomes. Exemplary desired outcomes can include increasing relative inside air pressure at the premises to minimize unfiltered air infiltration into the premises and/or creating pressure differentials between interior zones to induce an intended direction of air flow, for instance reducing a supply of air, and air flow to, a particular zone for which pressure change data indicates a presence of a hazardous event. The control functions (e.g., coordinated damper positioning control using pressure data followed by HVAC unit blower control) to achieve such desired outcomes can be dynamic and can be in response to outside and/or inside pressure sensor readings.

In some embodiments, referring back to FIG. 4, system 1700 can include a hazard database 1735. Data collection module 1728 can collect data from sensors in the system 1700 (e.g., from pressure sensor(s) 1704, from other sensor(s) 1703), such as pressure data, humidity data, temperature data, gas data, etc. and this data can be stored in hazard database 1735 for use in determining a presence of a hazard condition at the premises. This received data can be compared to the hazard database, which can include one or more predetermined pressure signature and/or predetermined pressure change thresholds corresponding to different types of hazard conditions. If the collected sensor data matches one of the predetermined pressure signature and/or predetermined pressure change thresholds corresponding to a particular type of hazard condition, the hazard database 1735 can be used to determine and extract a corresponding output for that particular type of hazard condition.

As one example, if pressure data at an air duct changes (e.g., increases) to match a predetermined air duct pressure signature and/or predetermined air duct pressure change threshold, this may be indicative of a blockage present in the air duct, and the hazard database 1735 can be used to determine and extract a corresponding output, such as a notification to a specified remote device, for air duct blockage. As another example, if pressure data received from an interior pressure sensor indicates a change (e.g., increase) in pressure data at zone Z1 matching a predetermined pressure signature and/or a predetermined interior pressure change threshold stored the hazard database 1735 and if temperature, humidity, and/or gas data received from a respective interior sensor indicates a change (e.g., increase) in temperature, humidity, and/or gas data at zone Z1 matching a predetermined interior temperature, humidity, or gas change threshold stored at the hazard database 1735, this may indicative of a fire or gas leak present at zone Z1. Hazard database 1735 can be used to determine and extract a corresponding output, such as a notification to a specified remote device and/or an adjustment to the HVAC system 1714 (e.g., an adjustment to one or more dampers 1724) to adjust a volume of air supplied to zone Z1 so as to help reduce the hazard posed by the determined hazard condition at Zone Z1 (e.g., where the received sensor data is indicative of a fire event at zone Z1 to reduce combustible material at zone Z1, reduce the volume of air supplied to zone Z1; where the received sensor data is indicative of a gas leak event at zone Z1, increase the volume of air supplied to zone Z1 to dilute gas at zone Z1 or push gas from Z1 toward an exterior air output).

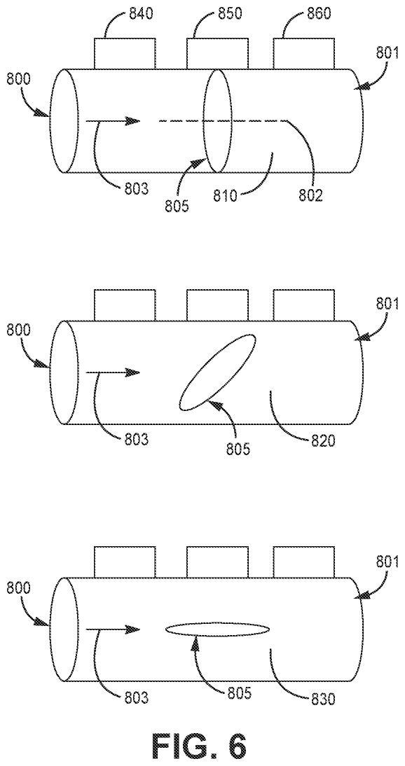

FIG. 6 is a diagram illustrating a damper 800, at an air duct, configured to incrementally control air flow, via one or more damper positions incrementally between fully closed and fully open. The damper 800 can be one example of a damper utilized in the system 2000 described previously herein (e.g., an example of a type of damper that can be utilized as one or more of dampers 6100, 6200, 6300, 7000, 7005, 7100, 7200, 7500).

The damper 800 can include a damper blade 805 that is movable relative to a body 801 of the damper 800. The damper blade 805 can be movable about an axis 802, and in the illustrated embodiment the axis 802 is generally parallel to, and can be coincident with, a central longitudinal axis of the body 801. Damper blade 805 can pivot about the axis 802 to change a position of damper blade 805 to a variety of incremental positions, including fully closed, fully opened, and a number of discrete positions between fully closed and fully opened.

At damper blade position 810, damper blade 805 is at a fully closed position. The exemplary fully closed position 820 shown here positions damper blade 805 generally at ninety degrees relative to a direction 803 of air flow through the damper body 801. Upon receiving an actuation command, such as from the controller, damper 800 can be configured to adjust damper blade positioning from the fully closed position 810 to a different position corresponding to the actuation command received at the damper 800. For example, upon receiving an actuation command (e.g., a partially open command), damper blade 805 can move (e.g., rotate about the axis 802) relative to damper body 801 from the fully closed position 810 to a partially opened position 820. The exemplary partially opened position 820 shown here positions damper blade 805 generally at forty-five degrees relative to direction 803 of air flow through the damper body 801. As another example, upon receiving an actuation command (e.g., a fully open command), damper blade 805 can move (e.g., rotate about the axis 802) relative to damper body 801 from the partially opened position 820 to a fully opened position 830. The exemplary fully opened position 830 shown here positions damper blade 805 generally parallel relative to direction 803 of air flow through the damper body 801 (e.g., and generally on the rotational axis 802 of damper blade 805). As will be appreciated, damper blade 805 can be positioned at a variety of other positions between the illustrated fully closed position 810, partially opened position 820, and fully opened position 830.

As damper blade 805 is moved to adjust its position inside damper body 801, this can change an obstruction area to the air flow, and thus a degree to which air flow entering damper body 801 is obstructed in its flow, and thereby can act to regulate a volume of air passing through damper 800.

Damper 800 can include a receiver and associated programmable control circuitry 850 at damper body 801. Receiver and associated programmable control circuitry 850 can receive (via hard wiring or wirelessly) an actuation command from controller 2100 and, as a result, cause a position of damper blade 805 to change to a degree corresponding to the actuation command. As such, damper 800 can act to obstruct air flow through damper 800 to a variety of degrees in correspondence to the actuation command and data received at controller 2100 (e.g., pressure data).

In some examples, a pressure sensor, temperature sensor, humidity sensor, and/or air quality sensor can be mounted at damper inlet 840 and/or damper outlet 860. In one such example, perforations can be included in the damper wall to allow air within damper body 801 to be in fluid communication with any one or more such sensors at damper body 801. Any so include such sensor can be in communication with controller 2100, for instance by including a transmitter along with receiver and associated programmable control circuitry 850. Including such additional one or more sensors at damper 800 can allow for inlet and outlet pressure, temperature, humidity and/or air quality to be monitored at the air flowing through damper 800.

In some cases, including a pressure sensor at the input side of damper 800 (e.g., damper 6100, 6200, 6300, 7000, 7005, 7100, 7200, and/or 7500) can further certain useful advantages. Having a pressure sensor at one or more dampers could allow for management of return air proportions based on the sensed pressure at the dampers. Damper sensed pressures can be used to balance return air distribution for dampers (e.g., damper 7000, 7005, 7100, 7200, and/or 7500) for the purpose of redistributing zone air between zones Z1, Z2, Zn. Damper sensed pressures can also be used to balance inside and outside return air source percentages by monitoring dampers 7000, 7005, 7100, 7200, and/or 7500. This could allow for a more precise control of coordinated HVAC return air pressure while adjusting the proportions for blended inside and outside air as described previously.

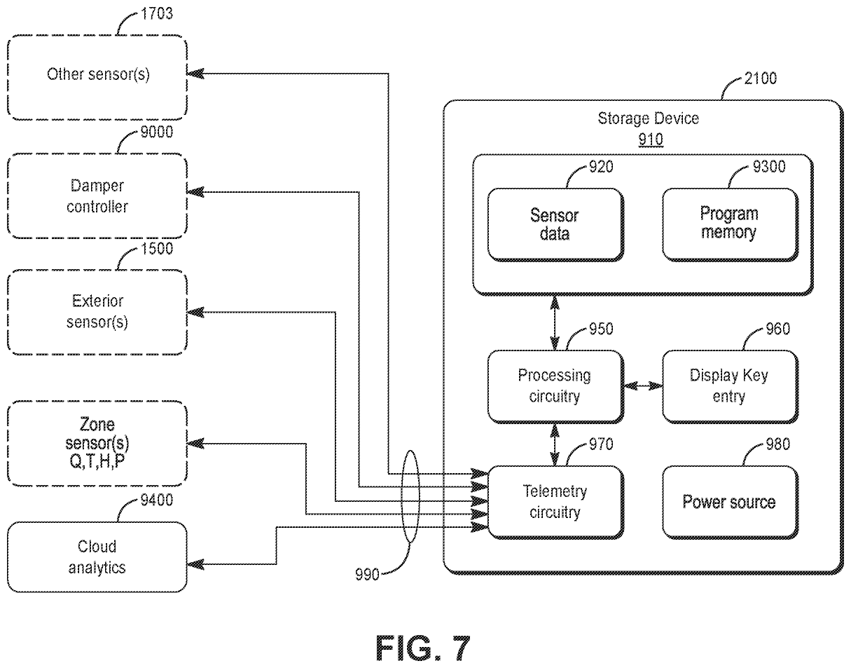

FIG. 7 is a block diagram illustrating the controller 2100 for determining and causing an output that is associated at least with a change in pressure, in accordance with one or more techniques described herein.

As shown in the illustrated example, controller 2100 can include programmable processing circuitry 950 configured to execute computer-executable instructions included at a non-transitory computer-readable storage article 9300. Telemetry circuitry 970 (e.g., a wireless transceiver) can receive (e.g., via communication link(s) 990), non-transitory computer-readable storage article 9300 can store, and programmable processing circuitry 950 can process sensor data from one or more sensors, such as other sensor(s) 1703 (e.g., gas and/or fire sensor; a glass break sensor; a motion sensor; a camera; a door/window contact sensor; etc.), exterior sensors 1500 (e.g., air quality sensor Q0, temperature sensor TO, humidity sensor H0, and/or pressure sensor P0) and/or interior sensors, such as one or more of zone Z1 sensors (e.g., air quality sensor Q1, temperature sensor T1, humidity sensor H1, and/or pressure sensor P1), zone Z2 sensors (e.g., air quality sensor Q2, temperature sensor T2, humidity sensor H2, and/or pressure sensor P2), and zone Zn sensors (e.g., air quality sensor Qn, temperature sensor Tn, humidity sensor Hn, and/or pressure sensor Pn). Power source 980 can supply power to the controller 210 and can be a replaceable or rechargeable battery or line power.

Program memory 9300 can store one or more control programs in the form of computer-executable instructions for execution by programmable processing circuitry 950 to carry out one or more actions described elsewhere herein. Such control programs can include commands for the HVAC system at the premises to manage air flow at the premises, commands for the security system at the premises to take one or more security actions, and/or other actions described elsewhere herein. As one example, programmable processing circuitry 950 can read the received sensor data (e.g., pressure data), determine a state of the HVAC system (e.g., determine a state, or position, of one or more dampers as described previously), and convey one or more control commands to one or more components of the HVAC system (e.g., through damper controller 9000) to actuate such one or more components of the HVAC system (e.g., one or more dampers) to a component state based on the received sensor data (e.g., pressure data). Telemetry circuitry 970 can send control information to and/or receive control information from one or more HVAC system components, such as one or more dampers. Likewise, telemetry circuitry 970 can send data to and/or receive data from (e.g., a remote control command) a remote server (e.g., “cloud” computing and analytics) 9400. The remote server 9400 can, in some cases, be leveraged to process data remote from the premises, for instance by executing one or more machine learning algorithms that use past premises data, such as from the interior and/or exterior sensors at the premises and/or one or more components of premises HVAC system, to determine one or more patterns associated with HVAC system control actions and resulting changes to data sensed by interior and/or exterior sensors at the premises. In certain embodiments, controller 2100 can include a user interface, such as display key entry 960, configured to receive user input, such as setting one or more operational parameters for operation of system 2000, and to output one or more indicators as to set parameters for operation of system 2000 and/or alerts as to one or more preset conditions at system 2000.

Thus, one exemplary controller 2100 embodiment can include non-transitory computer-readable storage article 9300 including computer-executable instructions (e.g., control program) and programmable processing circuitry 950 that is configured to execute the computer-executable instructions to cause programmable processing circuitry 950 to: receive detected air pressure data within the premises from a first pressure sensor (e.g., P1) at a first time and a second, different time, determine a change in pressure within the premises using at least the first air pressure and the second air pressure, compare the change in pressure within the premises to a first predetermined interior pressure signature and/or a first predetermined interior pressure change threshold, and, when the change in pressure within the premises matches the first predetermined interior pressure signature and/or first predetermined interior pressure change threshold, determine a first output associated with the first predetermined pressure signature and/or first predetermined interior pressure change threshold. As one example, the first predetermined pressure signature and/or first predetermined interior pressure change threshold can correspond to opening of a door or window, and the first output determined by the controller as associated with the first predetermined pressure signature and/or first predetermined interior pressure change threshold can be an entry alert to a remote device. In this example embodiment of the controller 2100, programmable processing circuitry 950 can be configured to execute the computer-executable instructions to further cause programmable processing circuitry 950 to compare the change in pressure within the premises to a second predetermined interior pressure signature and/or second predetermined interior pressure change threshold, and, when the change in pressure within the premises matches the second predetermined interior pressure signature and/or second predetermined interior pressure change threshold, determine a second output associated with the second predetermined interior pressure signature and/or second predetermined interior pressure change threshold, with the second predetermined interior pressure signature and/or second predetermined interior pressure change threshold being different than the respective first predetermined interior pressure signature and/or first predetermined interior pressure change threshold. For instance, the second predetermined interior pressure signature and/or second predetermined interior pressure change threshold can correspond to a presence of a person at the premises, and the second output determined by the controller as associated with the second predetermined interior pressure signature and/or second predetermined interior pressure change threshold can be an intruder alert to a remote device.

In a further exemplary embodiment of this controller 2100, programmable processing circuitry 950 can be configured to execute the computer-executable instructions to further cause programmable processing circuitry 950 to receive security data at the premises from a security sensor at the premises in communication with controller 2100 and, when both the change in pressure within the premises matches the first predetermined pressure signature and/or first predetermined interior pressure change threshold and the security data matches a first predetermined premises security threshold, determine a first output associated with each of the first predetermined pressure signature and/or first predetermined interior pressure change threshold and the first predetermined premises security threshold.

In a further exemplary embodiment of this controller 2100, programmable processing circuitry 950 can be configured to execute the computer-executable instructions to further cause programmable processing circuitry 950 to communicate with a HVAC unit (e.g., HVAC unit 2002) that is at the premises, and the first output associated with the first predetermined interior pressure signature and/or first predetermined interior pressure change threshold is a HVAC adjustment command such that, when the change in pressure within the premises matches the first predetermined pressure signature and/or first predetermined interior pressure change threshold, the controller is configured to transmit the HVAC adjustment command to the HVAC unit. For instance, the first predetermined interior pressure signature and/or first predetermined interior pressure change threshold can correspond to a presence of a person within the premises, and the first output determined by the controller as associated with the first predetermined interior pressure signature and/or first predetermined interior pressure change threshold can be a HVAC adjustment command to the HVAC unit to change a temperature set point setting. This can be helpful to adjust a temperature at a zone of a premises at which pressure data indicates a person is present, and, thereby, help to increase HVAC system efficiency. In another instance, the first predetermined interior pressure signature and/or first predetermined interior pressure change threshold can correspond to a presence of an interior hazard (e.g., fire or gas) within the premises, and the first output determined by the controller as associated with the first predetermined interior pressure signature and/or first predetermined interior pressure change threshold can be an HVAC adjustment command to the HVAC unit. In particular, where the interior hazard is a fire, the HVAC adjustment command can be a damper adjustment command to restrict air supply provided within the premises (e.g., reduce a volume of air supplied to a zone at which received pressure data is indicative of a presence of a fire). The controller's programmable processing circuitry 950 can be configured to execute the computer-executable instructions to further cause programmable processing circuitry 950 to communicate with a gas or fire sensor to receive gas or fire data at the premises from the gas or fire sensor and, when both the change in pressure within the premises matches the first predetermined interior pressure signature and/or first predetermined interior pressure change threshold and the gas or fire data matches a first predetermined premises gas or fire threshold, determine a first output associated with each of the first predetermined interior pressure signature and/or first predetermined interior pressure change threshold and the first predetermined premises gas or fire threshold.

In certain embodiments, controller 2100 can receive and use pressure data from more than one pressure sensor. For example, controller 2100 can receive pressure data from a second pressure sensor configured to detect a third air pressure exterior to the premises at a third time and a fourth air pressure exterior to the premises at a fourth, different time. Controller 2100's programmable processing circuitry 950 can be configured to execute the computer-executable instructions to further cause programmable processing circuitry 950 to receive the third air pressure and the fourth air pressure exterior to the premises from the second pressure sensor, determine a change in pressure exterior to the premises using at least the third air pressure and the fourth air pressure, compare the change in pressure exterior to the premises to a first predetermined exterior pressure signature and/or first predetermined exterior pressure change threshold, and, when the change in pressure exterior to the premises matches the first predetermined exterior pressure signature and/or first predetermined exterior pressure change threshold, determine a second output associated with the first predetermined exterior pressure signature and/or first predetermined exterior pressure change threshold.

For instance, the first predetermined exterior pressure signature and/or first predetermined exterior pressure change threshold can correspond to a weather condition exterior to the premises, and the second output determined by the controller as associated with the first predetermined exterior pressure signature and/or first predetermined exterior pressure change threshold can be a weather condition alert to a remote device. In addition, the first predetermined interior pressure signature and/or first predetermined interior pressure change threshold can correspond to opening of a door or window, and the first predetermined exterior pressure signature and/or first predetermined exterior pressure change threshold can correspond to a weather condition exterior to the premises, and, when both the change in pressure within the premises matches the first predetermined interior pressure signature and/or first predetermined interior pressure change threshold and the change in pressure exterior to the premises matches the first predetermined exterior pressure signature and/or first predetermined exterior pressure change threshold, controller 2100's programmable processing circuitry 950 can be configured to execute the computer-executable instructions to further cause programmable processing circuitry 950 to generate a door or window alert to a remote device. In one such specific example of this, the first predetermined exterior pressure change threshold can correspond to a first weather condition exterior to the premises and a second predetermined exterior pressure change threshold corresponds to a second, different weather condition exterior to the premises, and, when the change in pressure exterior to the premises matches the first predetermined exterior pressure change threshold, controller 2100's programmable processing circuitry 950 can be configured to execute the computer-executable instructions to further cause programmable processing circuitry 950 to generate the door or window alert to the remote device, and, when the change in pressure exterior to the premises matches the second predetermined exterior pressure change threshold, controller 2100's programmable processing circuitry 950 can be configured to execute the computer-executable instructions to further cause programmable processing circuitry 950 to generate a shelter alert to a remote device.

In another instance, the first predetermined exterior pressure change threshold can correspond to a weather condition exterior to the premises, and the second output determined by the controller as associated with the first predetermined exterior pressure change threshold can be a damper adjustment command to adjust an air damper at the premises to change a volume of air passing through the damper. This can be useful in selectively supplying and directing air within the premises depending on the presence of the weather condition exterior to the premises.

Thus, with respect to system 1700 shown at the exemplary embodiment of FIG. 4, system 1700 can include a weather database 1737. Data collection module 1728 can collect data from sensors in the system 1700 (e.g., from exterior pressure sensor 1704, from other sensor(s) 1703), such as exterior pressure data, exterior humidity data, exterior temperature data, etc. and this data can be stored in weather database 1737 for use in determining a presence of a weather condition at the premises. This received data can be compared to the weather database, which can include one or more predetermined pressure change thresholds corresponding to different types of weather conditions. If the collected sensor data matches one of the predetermined pressure change thresholds corresponding to a particular type of weather condition, the weather database 1737 can be used to determine and extract a corresponding output for that particular type of weather condition. This could include, for example, when data from a window contact sensor 1703 indicates that a window is open and processing circuitry 1706 determines that exterior pressure data from one or more exterior pressure sensors matches a first predetermined exterior pressure change threshold stored at weather database 1737, processing circuitry 1706 can determine and extract an output from weather database 1737 corresponding to the first predetermined exterior pressure change threshold and thus corresponding to the detected exterior weather event. The weather database 1737 can store various, different predetermined exterior pressure change thresholds each corresponding to different types of weather events, such as a rainstorm, hurricane, tornado, etc. For example, collected exterior premises pressure data could be 965 to 979 millibars, which indicate conditions for a category 2 hurricane. In this case, the output stored at the weather database 1737 and matching the noted collected exterior premises pressure data can be a notification to a remote user device to close windows at the premises. In another example, collected exterior premises pressure data could be less than 920 millibars, which indicates conditions for a category 5 hurricane. In this case, the output stored at the weather database 1737 and matching the noted collected exterior premises pressure data can be a notification to a remote user device to take shelter immediately. As an additional example, collected exterior premises pressure data could drop below 29.80inHg, which indicates conditions for an anticipated rainstorm. In this case, the output stored at the weather database 1737 and matching the noted collected exterior premises pressure data can be a notification to a remote user device that a rainstorm is anticipated to occur at the premises.

Embodiments disclosed herein can additionally sense and use pressure data at an enclosed parking structure to help inform, and in some cases cause, remediation action(s) to occur.

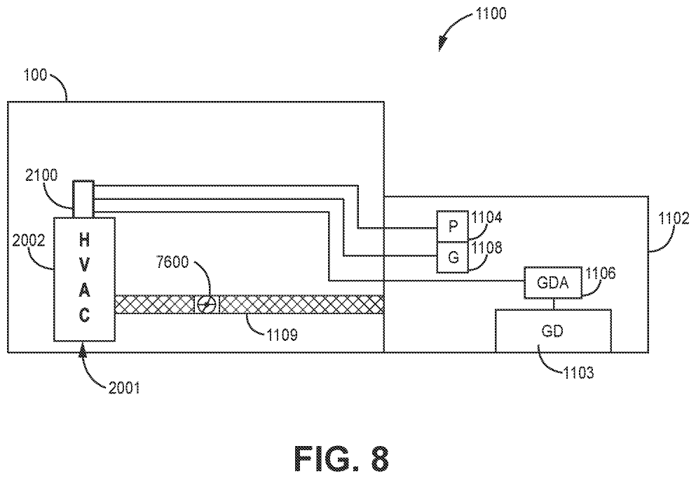

FIG. 8 is a block diagram illustrating an embodiment of a system 1100 for detecting a hazard condition at an enclosed parking structure 1102. Enclosed parking structure 1102 can be a generally enclosed space within which one or more vehicles are intended to be parked. One example of an enclosed parking structure can be a garage attached to a premises, such as a home. Enclosed parking structure 1102 can include a garage door 1103 that is configured to move between closed and open positions, with the garage door 1103 generally being in the closed position when a vehicle is not entering or leaving enclosed parking structure 1102 and generally being in the open position when a vehicle is entering or leaving enclosed parking structure 1102. When garage door 1103 is in the closed position, naturally occurring air circulation, such as external air introduction into the enclosed parking structure 1102, can be reduced, thus creating a potential hazard condition when a vehicle is left running in the enclosed parking 1102 structure while garage door 1103 is closed. System 1100 can be configured to detect a presence of a running vehicle at the enclosed parking structure 1102 and, as a result, cause one or more actions to be taken to remediate a potential hazard (e.g., accumulated carbon monoxide) presented by the running vehicle at enclosed parking structure 1102.

System 1100 can include controller 2100, pressure sensor 1104, and garage door actuator 1106. Pressure sensor 1104 can be configured to detect a first air pressure within the enclosed parking structure 1102 at a first time and a second air pressure within the enclosed parking structure 1102 at a second, different time. Controller 2100 can be in communication with pressure sensor 1104 to receive pressure data sensed by pressure sensor 1104, including pressure data sensed by pressure sensor 1104 at the first time and the second, different time. Controller 2100 can be configured to determine a change in pressure within enclosed parking structure 1102 using at least the first air pressure within the enclosed parking structure 1102 and the second air pressure within the enclosed parking structure 1102. Controller can further be configured to compare the change in pressure within enclosed parking structure 1102 to a first predetermined interior pressure signature and/or first predetermined interior pressure change threshold, and, when the change in pressure within enclosed parking structure 1102 matches the first predetermined interior pressure signature and/or first predetermined interior pressure change threshold, determine a first output associated with the first predetermined interior pressure signature and/or first predetermined interior pressure change threshold.

For instance, the predetermined interior pressure signature and/or predetermined interior pressure change threshold can correspond to a presence of a vehicle at enclosed parking structure 1102 at premises 100. More specifically, the predetermined interior pressure signature and/or predetermined interior pressure change threshold can correspond to a presence of a vehicle with a running engine at enclosed parking structure 1102 at premises 100. For instance, one exemplary process for using the predetermined interior pressure signature and/or predetermined interior pressure change threshold corresponding to a presence of a vehicle with a running engine at enclosed parking structure 1102 can be as follows.

When the garage door 1103 is opened, controller 2100 can determine a first pressure change within enclosed parking structure 1102, based on pressure data from pressure sensor 1104 at a first time before the garage door is opened and at a second, different time when the garage door is opened, matches a first predetermined interior pressure signature and/or first predetermined interior pressure change threshold that corresponds to garage door 1103 transitioned from the closed to the opened position. Then, after garage door 1103 is opened, controller 2100 can determine a second, different pressure change within enclosed parking structure 1102, based on pressure data from the pressure sensor 1104 at a third time when the garage door is opened and at a fourth time when a vehicle has entered enclosed parking structure 1102, matches a second predetermined interior pressure signature and/or second predetermined interior pressure change threshold that corresponds to a vehicle having entered enclosed parking structure 1102. And, once controller 2100 has determined that the vehicle has entered enclosed parking structure 1102, controller 2100 has monitor subsequently received pressure data from pressure sensor 1104 to detect a preset pressure change at enclosed parking structure 1102 that corresponds to an engine of the vehicle that has entered enclosed parking structure 1102 transitioned from running to off. If, after having determined that the second pressure change within enclosed parking structure 1102 matches the second predetermined interior pressure signature and/or second predetermined interior pressure change threshold that corresponds to a vehicle having entered enclosed parking structure 1102, controller 2100 does not detect the preset pressure change at enclosed parking structure 1102 that corresponds to an engine of the vehicle that has entered enclosed parking structure 1102 transitioned from running to off within a predetermined time period after having determined that the second pressure change within enclosed parking structure 1102 matches the second predetermined interior pressure signature and/or second predetermined interior pressure change threshold that corresponds to a vehicle having entered enclosed parking structure 1102, controller 2100 can determine that the vehicle has continued to have its engine running while within enclosed parking structure and controller 2100 can generate a corresponding output, such as generating a signal for alerting a user's remote device as to a running vehicle at enclosed parking structure 1102 and/or generating an actuation command to cause garage door actuator 1106 to open garage door 1103.

As noted, garage door actuator 1106 can be configured to open and close garage door 1103 at enclosed parking structure 1102. As such, the first output determined by controller 2100 as associated with the first predetermined interior pressure signature and/or first predetermined interior pressure change threshold can be an actuation command to cause garage door actuator 1106 to open or close garage door 1103 at enclosed parking structure 1102. When controller 2100 determines that a predetermined pressure signature and/or predetermined pressure change threshold corresponding to a vehicle having entered enclosed parking structure 1102 and maintaining its engine in a running state for a predetermined time period, after controller 2100 determined that a different predetermined interior pressure signature and/or predetermined interior pressure change threshold, corresponding to a vehicle having entered enclosed parking structure 1102 is met by the received pressure data, controller 2100 can generate the actuation command to cause garage door actuator 1106 to open garage door 1103. Thus, controller 2100 can be in communication with garage door actuator 1106, and garage door actuator 1106 can be in communication with garage door 1103 (e.g., via a motorized drive for moving garage door 1103 between the opened and closed positions) to execute the actuation command from controller 2100 to open/close garage door 1103.

In one further embodiment, system 110 can further include a gas sensor 1108. Gas sensor 1108 can be configured to detect a concentration of gas (e.g., carbon monoxide) at enclosed parking structure 1102, and gas sensor 1108 can be in communication with controller 2100 such that controller 2100 can receive gas data sensed by gas sensor 1108. In some embodiments, controller 2100 can use gas data from gas sensor 1108 along with pressure data from pressure sensor 1104 to determine when to generate an output at controller 2100 and what type of output should be generated at controller 2100. For example, controller 2100 can be configured to receive data relating to a concentration of gas at enclosed parking structure 1102 from the gas sensor 1108, compare the data relating to the concentration of gas to a first predetermined gas threshold, and, when the change in pressure within enclosed parking structure 1102 matches a first predetermined interior pressure signature and/or first predetermined interior pressure change threshold (e.g., corresponding to a vehicle having entered enclosed parking structure 1102 and maintaining its engine in a running state for a predetermined time period) and the concentration of gas matches the first predetermined gas threshold, generate the actuation command to cause garage door actuator 1106 to open the garage door 1103. In some such cases, the gas data from gas sensor 1108 can provide one or more data points in addition to the pressure data at enclosed parking structure 1102 and can help to increase the accuracy of controller 2100's determinations as to a presence of a potential hazard at enclosed parking structure 1102. In one such case, where the first predetermined interior pressure signature and/or first predetermined interior pressure change threshold corresponds to a presence of a vehicle with a running motor at enclosed parking structure 1102, controller 2100 can determine that the change in pressure within enclosed parking structure 1102 matches the first predetermined interior pressure signature and/or first predetermined interior pressure change threshold prior to determining that the concentration of gas matches the first predetermined gas threshold.

In some further embodiments, such as the illustrated embodiment, system 1100 can further include HVAC system 2001, and controller 2100 can be in communication with HVAC system 2001. In such embodiments, when controller 2100 determines a presence of a potential hazard at enclosed parking structure 1102 (e.g., using pressure data and/or gas data as described above), one or more resulting outputs determined by controller 2100 can be a command to HVAC system 2001 to adjust one or more components of HVAC system 2001, for instance, to help remediate the potential hazard at enclosed parking structure 1102. As such, the one or more commands generated by controller 2100 for HVAC system 2001 can relate to adjustments to one or more components of HVAC system 2001 in fluid communication with enclosed parking structure 1102. As one example, HVAC system 2001 can include an air duct 1109 in fluid communication with HVAC unit 2002 and enclosed parking structure 1102, and this air duct 1109 can include an air damper 7600 such as described elsewhere herein. In this example, the first output determined by controller 2100 as associated with the first predetermined interior pressure signature and/or first predetermined interior pressure change threshold can be a damper adjustment command to adjust air damper 7600, in fluid communication with enclosed parking structure 1102, to change a volume of air passing through the damper 7600 and, thus, to change a volume of air passing to enclosed parking structure 1102. For instance, when controller 2100 determines at least that pressure data from pressure sensor 1104 matches the first predetermined interior pressure signature and/or first predetermined interior pressure change threshold, controller 2100 can generate the damper adjustment command to cause air damper 7600 to increase the volume of air flowing from HVAC unit 2002 to enclosed parking structure 1102. This increase in the volume of air being introduced by HVAC system 2001 to enclosed parking structure 1102 can act to cause air pressure at enclosed parking structure 1102 to increase and help to flush out potentially hazardous gas at enclosed parking structure 1102 and decrease any hazardous gas potentially passing from enclosed parking structure 1102 to premises 100. In conjunction with generating the damper adjustment command, controller 2100 can also generate the actuation command to cause garage door actuator 1106 to open garage door 1103.

Thus, in operation, system 1100 can function to use one or more types of various data collected at enclosed parking structure 1102 and, based on that data, cause one or more actions relating to enclosed parking structure 1102 to be taken. In some cases, controller 2100 can include, or access, a safety module that compares the collected sensor data to a safety database, which can include one or more different sensor data safety thresholds, such as carbon monoxide levels, pressure noise data thresholds that indicate a vehicle is in the enclosed structure and/or is running, a time threshold for how long a vehicle is running, etc. If such safety module determines there is a match between the collected sensor data and the data stored in the safety database, then a corresponding safety action can be executed by controller 2100 and sent to HVAC unit 2002, damper 7600, and/or garage door actuator 1106. As one specific such example, if pressure data and/or gas data indicates a vehicle is located within enclosed parking structure 1102 and has been running for over a preset time (e.g., three minutes), the safety action extracted by controller 2100 can be to signal the garage door opener to open the garage door to ventilate the enclosed structure and/or to adjust a position of damper 7600 to adjust a flow of air between HVAC unit 2002 and enclosed parking structure 1102.

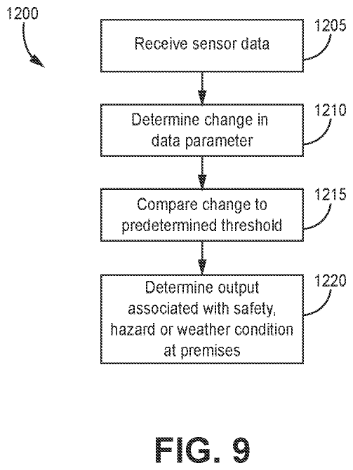

FIG. 9 illustrates an exemplary flow diagram of a method 1200 for using sensor data to detect one or more security, hazard, and/or weather conditions at a premises and determine one or more outputs associated with the detected one or more security, hazard, and/or weather conditions at the premises. In some examples, method 1200 can be carried out at the controller, for instance, at system embodiments disclosed elsewhere herein.

At step 1205 method 1200 includes receiving sensor data. For example, the sensor data can be received at the controller, and the received sensor data can be any one or more types of sensor data disclosed elsewhere herein, such as interior premises pressure data received from a pressure sensor interior to the premises and/or exterior premises pressure data received from a pressure sensor exterior to the premises. In a further such example, non-pressure data (e.g., from a security sensor) can also be received at the controller.

At step 1210, method 1200 includes determining a change in at least one data parameter of the received sensor data. For example, the change in at least one data parameter can be a change in pressure interior to the premises and/or exterior to the premises. In a further such example, the change in at least one data parameter can additionally be a change in non-pressure data (e.g., from a security sensor).

At step 1215, method 1200 includes comparing the change in the at least one data parameter to a predetermined pressure signature and/or predetermined data change threshold. For example, a change in pressure interior to the premises and/or exterior to the premises can be compared, respectively, to a predetermined interior pressure change threshold or signature and/or a predetermined exterior pressure change threshold or signature. In a further such example, a change in non-pressure data (e.g., from a security sensor) can be compared to a predetermined non-pressure change threshold (e.g., a security threshold).

And, at step 1220, method 1200 includes, when the change in the at least one data parameter matches the predetermined data change threshold and/or predetermined data change signature, determining at least one output associated with at least one safety, hazard, and/or weather condition that corresponds to the predetermined data change threshold and/or predetermined data change signature. One example of this output determination step can include causing a security system alarm condition to be actuated at the premises as associated with a presence of an intruder that corresponds at least to the interior change in pressure matching a predetermined interior pressure change threshold and/or predetermined interior pressure signature. Another example of this output determination step can include causing an adjustment to a component of a HVAC system at the premises as associated with a presence of a fire or gas leak that corresponds at least to the interior change in pressure matching a predetermined interior pressure change threshold and/or predetermined interior pressure signature. A still further example of this output determination step can include causing an alert to be generated as associated with an open door/window state at the premises at a time when a weather event is occurring, or anticipated to occur, that corresponds at least to the exterior change in pressure at the premises matching a predetermined exterior pressure change threshold and/or predetermined exterior pressure signature.

It is to be recognized that depending on the example, certain acts or events of any of the embodiments, including method embodiments, described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

The following provides an exemplary, numbered listing of certain embodiments within the scope of the present disclosure.
1. A system comprising: a controller; a first pressure sensor configured to detect a first air pressure within a premises at a first time and a second air pressure within the premises at a second time, the first pressure sensor in communication with the controller, the first time being different than the second time; wherein the controller is configured to receive the first air pressure and the second air pressure within the premises from the first pressure sensor, determine a change in pressure within the premises using at least the first air pressure and the second air pressure, compare the change in pressure within the premises to a first predetermined interior pressure change threshold and/or predetermined interior pressure signature, and, when the change in pressure within the premises matches the first predetermined interior pressure change threshold and/or first predetermined interior pressure signature, determine a first output associated with the first predetermined interior pressure change threshold and/or first predetermined interior pressure signature.
2. The system of embodiment 1, wherein the first predetermined interior pressure change threshold and/or first predetermined interior pressure signature corresponds to opening of a door or window, and wherein the first output determined by the controller as associated with the first predetermined interior pressure change threshold and/or first predetermined interior pressure signature is an entry alert to a remote device.
3. The system of any one of embodiments 1 or 2, wherein the controller is further configured to compare the change in pressure within the premises to a second predetermined interior pressure change threshold and/or a second predetermined interior pressure signature, and, when the change in pressure within the premises matches the second predetermined interior pressure change threshold and/or the second predetermined interior pressure signature, determine a second output associated with the second predetermined interior pressure change threshold and/or the second predetermined interior pressure signature, wherein the second predetermined interior pressure change and/or second predetermined interior pressure signature threshold is different than the respective first predetermined interior pressure change threshold and/or first predetermined interior pressure signature.
4. The system of any one or embodiments 1, 2, or 3, wherein the second predetermined interior pressure change threshold and/or second predetermined interior pressure signature corresponds to a presence of a person at the premises, and wherein the second output determined by the controller as associated with the second predetermined interior pressure change threshold and/or second predetermined interior pressure signature is an intruder alert to a remote device.
5. The system of any one of embodiments 1, 2, 3, or 4, further comprising: security sensor in communication with the controller, wherein the controller is further configured to receive security data at the premises from the security sensor and, when both the change in pressure within the premises matches the first predetermined interior pressure change threshold and/or first predetermined interior pressure signature and the security data matches a first predetermined premises security threshold, determine a first output associated with each of the first predetermined interior pressure change threshold and/or first predetermined interior pressure signature and the first predetermined premises security threshold.
6. The system of any one of embodiments 1, 2, 3, 4, or 5, further comprising: a heating, ventilation, and air conditioning (HVAC) unit at the premises and in communication with the controller, wherein the first output associated with the first predetermined interior pressure change threshold and/or first predetermined interior pressure signature is a HVAC adjustment command such that, when the change in pressure within the premises matches the first predetermined interior pressure change threshold and/or first predetermined interior pressure signature, the controller is configured to transmit the HVAC adjustment command to the HVAC unit.
7. The system of any one of embodiments 1, 2, 3, 4, 5, or 6, wherein the first predetermined interior pressure change threshold and/or first predetermined interior pressure signature corresponds to a presence of an interior hazard within the premises, and wherein the first output determined by the controller as associated with the first predetermined interior pressure change threshold and/or first predetermined interior pressure signature is an HVAC adjustment command to the HVAC unit.
8. The system of any one of embodiments 1, 2, 3, 4, 5, 6, or 7, wherein the interior hazard is a fire, and wherein the HVAC adjustment command is a damper adjustment command to restrict air supply provided within the premises.
9. The system of any one of embodiments 1, 2, 3, 4, 5, 6, 7, or 8, further comprising: a gas or fire sensor in communication with the controller, wherein the controller is further configured to receive gas or fire data at the premises from the gas or fire sensor and, when both the change in pressure within the premises matches the first predetermined interior pressure change threshold and/or first predetermined interior pressure signature and the gas or fire data matches a first predetermined premises gas or fire threshold, determine a first output associated with each of the first predetermined interior pressure change threshold and/or first predetermined interior pressure signature and the first predetermined premises gas or fire threshold.
10. The system of any one of embodiments 1, 2, 3, 4, 5, 6, 7, 8, or 9, wherein the first predetermined interior pressure change threshold and/or first predetermined interior pressure signature corresponds to a presence of a person within the premises, and wherein the first output determined by the controller as associated with the first predetermined interior pressure change threshold and/or first predetermined interior pressure signature is an HVAC adjustment command to the HVAC unit to change a temperature set point setting.
11. The system of any one of embodiments 1, 2, 3, 4, 5, 6, 7, 8, 9, or 10, further comprising: a second pressure sensor configured to detect a third air pressure exterior to the premises at a third time and a fourth air pressure exterior to the premises at a fourth time, the second pressure sensor in communication with the controller, the third time being different than the fourth time; wherein the controller is configured to receive the third air pressure and the fourth air pressure exterior to the premises from the second pressure sensor, determine a change in pressure exterior to the premises using at least the third air pressure and the fourth air pressure, compare the change in pressure exterior to the premises to a first predetermined exterior pressure change threshold and/or a first predetermined exterior pressure signature, and, when the change in pressure exterior to the premises matches the first predetermined exterior pressure change threshold and/or first predetermined exterior pressure signature, determine a second output associated with the first predetermined exterior pressure change threshold and/or first predetermined exterior pressure signature.
12. The system of any one of embodiments 1, 2, 3, 4, 5, 6, 7, 8, 9, 10, or 11, wherein the first predetermined exterior pressure change threshold pressure signature corresponds to a weather condition exterior to the premises, and wherein the second output determined by the controller as associated with the first predetermined exterior pressure change threshold is a weather condition alert to a remote device.
13. The system of any one of embodiments 1, 2, 3, 4, 5, 6, 7, 8, 9, 10, 11, or 12, wherein the first predetermined interior pressure change threshold and/or first predetermined interior pressure signature corresponds to opening of a door or window, wherein the first predetermined exterior pressure change threshold corresponds to a weather condition exterior to the premises, and wherein, when both the change in pressure within the premises matches the first predetermined interior pressure change threshold and/or first predetermined interior pressure signature and the change in pressure exterior to the premises matches the first predetermined exterior pressure change threshold, the controller is configured to generate a door or window alert to a remote device.
14. The system of any one of embodiments 1, 2, 3, 4, 5, 6, 7, 8, 9, 10, 11, 12, or 13, wherein the first predetermined exterior pressure change threshold corresponds to a first weather condition exterior to the premises and a second predetermined exterior pressure change threshold corresponds to a second weather condition exterior to the premises, wherein, when the change in pressure exterior to the premises matches the first predetermined exterior pressure change threshold, the controller is configured to generate the door or window alert to the remote device, and wherein, when the change in pressure exterior to the premises matches the second predetermined exterior pressure change threshold, the controller is configured to generate a shelter alert to a remote device.
15. The system of any one of embodiments 1, 2, 3, 4, 5, 6, 7, 8, 9, 10, 11, 12, 13, or 14, wherein the first predetermined exterior pressure change threshold corresponds to a weather condition exterior to the premises, and wherein the second output determined by the controller as associated with the first predetermined exterior pressure change threshold is a damper adjustment command to adjust an air damper at the premises to change a volume of air passing through the damper.
16. The system of any one of embodiments 1, 2, 3, 4, 5, 6, 7, 8, 9, 10, 11, 12, 13, 14, or 15, wherein the first predetermined interior pressure change threshold and/or first predetermined interior pressure signature corresponds to a presence of a vehicle at an enclosed parking structure at the premises.
17. The system of any one of embodiments 1, 2, 3, 4, 5, 6, 7, 8, 9, 10, 11, 12, 13, 14, 15, or 16, further comprising: a garage door actuator configured to open and close a garage door at the enclosed parking structure, wherein the first output determined by the controller as associated with the first predetermined interior pressure change threshold and/or first predetermined interior pressure signature is an actuation command to cause the garage door actuator to open or close the garage door at the enclosed parking structure.
18. The system of any one of embodiments 1, 2, 3, 4, 5, 6, 7, 8, 9, 10, 11, 12, 13, 14, 15, 16, or 17, further comprising: a gas sensor configured to detect a concentration of gas at the enclosed parking structure, the gas sensor in communication with the controller, wherein the controller is configured to receive the concentration of gas at the enclosed parking structure from the gas sensor, compare the concentration of gas to a first predetermined gas threshold, and, when the change in pressure within the enclosed parking structure matches the first predetermined interior pressure change threshold and/or first predetermined interior pressure signature and the concentration of gas matches the first predetermined gas threshold, generate the actuation command to cause the garage door actuator to open the garage door.
19. The system of any one of embodiments 1, 2, 3, 4, 5, 6, 7, 8, 9, 10, 11, 12, 13, 14, 15, 16, 17, or 18, wherein the first predetermined interior pressure change threshold and/or first predetermined interior pressure signature corresponds to a presence of a vehicle with a running motor at an enclosed parking structure at the premises, and wherein the controller determines that the change in pressure within the enclosed parking structure matches the first predetermined interior pressure change threshold and/or first predetermined interior pressure signature prior to determining that the concentration of gas matches the first predetermined gas threshold.
20. The system of any one of embodiments 1, 2, 3, 4, 5, 6, 7, 8, 9, 10, 11, 12, 13, 14, 15, 16, 17, 18, or 19, wherein the first output determined by the controller as associated with the first predetermined interior pressure change threshold and/or first predetermined interior pressure signature is a damper adjustment command to adjust an air damper in fluid communication with the enclosed parking structure to change a volume of air passing through the damper.

Various examples of the disclosure have been described. Any combination of the described systems, operations, or functions is contemplated. These and other examples are within the scope of the following claims.

What is claimed is:

1. A system comprising:
a controller;
a first pressure sensor configured to detect a first air pressure within a premises at a first time and a second air pressure within the premises at a second time, the first pressure sensor in communication with the controller, the first time being different than the second time;
wherein the controller is configured to receive the first air pressure and the second air pressure within the premises from the first pressure sensor, determine a change in pressure within the premises using at least the first air pressure and the second air pressure, compare the change in pressure within the premises to a first predetermined interior pressure change threshold, and, when the change in pressure within the premises matches the first predetermined interior pressure change threshold, determine a first output associated with the first predetermined interior pressure change threshold.

2. The system of claim 1, wherein the first predetermined interior pressure change threshold corresponds to opening of a door or window, and wherein the first output determined by the controller as associated with the first predetermined interior pressure change threshold is an entry alert to a remote device.

3. The system of claim 2, wherein the controller is further configured to compare the change in pressure within the premises to a second predetermined interior pressure change threshold, and, when the change in pressure within the premises matches the second predetermined interior pressure change threshold, determine a second output associated with the second predetermined interior pressure change threshold, wherein the second predetermined interior pressure change threshold is different than the first predetermined interior pressure change threshold.

4. The system of claim 3, wherein the second predetermined interior pressure change threshold corresponds to a presence of a person at the premises, and wherein the second output determined by the controller as associated with the second predetermined interior pressure change threshold is an intruder alert to a remote device.

5. The system of claim 1, further comprising:
a security sensor in communication with the controller,
wherein the controller is further configured to receive security data at the premises from the security sensor and, when both the change in pressure within the premises matches the first predetermined interior pressure change threshold and the security data matches a first predetermined premises security threshold, determine a first output associated with each of the first predetermined interior pressure change threshold and the first predetermined premises security threshold.

6. The system of claim 1, further comprising:
a heating, ventilation, and air conditioning (HVAC) unit at the premises and in communication with the controller,
wherein the first output associated with the first predetermined interior pressure change threshold is a HVAC adjustment command such that, when the change in pressure within the premises matches the first predetermined interior pressure change threshold, the controller is configured to transmit the HVAC adjustment command to the HVAC unit.

7. The system of claim 6, wherein the first predetermined interior pressure change threshold corresponds to a presence of an interior hazard within the premises, and wherein the first output determined by the controller as associated with the first predetermined interior pressure change threshold is an HVAC adjustment command to the HVAC unit.

8. The system of claim 7, wherein the interior hazard is a fire, and wherein the HVAC adjustment command is a damper adjustment command to restrict air supply provided within the premises.

9. The system of claim 7, further comprising:
a gas or fire sensor in communication with the controller,
wherein the controller is further configured to receive gas or fire data at the premises from the gas or fire sensor and, when both the change in pressure within the premises matches the first predetermined interior pressure change threshold and the gas or fire data matches a first predetermined premises gas or fire threshold, determine a first output associated with each of the first predetermined interior pressure change threshold and the first predetermined premises gas or fire threshold.

10. The system of claim 6, wherein the first predetermined interior pressure change threshold corresponds to a presence of a person within the premises, and wherein the first output determined by the controller as associated with the first predetermined interior pressure change threshold is an HVAC adjustment command to the HVAC unit to change a temperature set point setting.

11. The system of claim 1, further comprising:
a second pressure sensor configured to detect a third air pressure exterior to the premises at a third time and a fourth air pressure exterior to the premises at a fourth time, the second pressure sensor in communication with the controller, the third time being different than the fourth time;
wherein the controller is configured to receive the third air pressure and the fourth air pressure exterior to the premises from the second pressure sensor, determine a change in pressure exterior to the premises using at least the third air pressure and the fourth air pressure, compare the change in pressure exterior to the premises to a first predetermined exterior pressure change threshold, and, when the change in pressure exterior to the premises matches the first predetermined exterior pressure change threshold, determine a second output associated with the first predetermined exterior pressure change threshold.

12. The system of claim 11, wherein the first predetermined exterior pressure change threshold corresponds to a weather condition exterior to the premises, and wherein the second output determined by the controller as associated with the first predetermined exterior pressure change threshold is a weather condition alert to a remote device.

13. The system of claim 11, wherein the first predetermined interior pressure change threshold corresponds to opening of a door or window, wherein the first predetermined exterior pressure change threshold corresponds to a weather condition exterior to the premises, and wherein, when both the change in pressure within the premises matches the first predetermined interior pressure change threshold and the change in pressure exterior to the premises matches the first predetermined exterior pressure change threshold, the controller is configured to generate a door or window alert to a remote device.

14. The system of claim 13, wherein the first predetermined exterior pressure change threshold corresponds to a first weather condition exterior to the premises and a second predetermined exterior pressure change threshold corresponds to a second weather condition exterior to the premises, wherein, when the change in pressure exterior to the premises matches the first predetermined exterior pressure change threshold, the controller is configured to generate the door or window alert to the remote device, and wherein, when the change in pressure exterior to the premises matches the second predetermined exterior pressure change threshold, the controller is configured to generate a shelter alert to a remote device.

15. The system of claim 11, wherein the first predetermined exterior pressure change threshold corresponds to a weather condition exterior to the premises, and wherein the second output determined by the controller as associated with the first predetermined exterior pressure change threshold is a damper adjustment command to adjust an air damper at the premises to change a volume of air passing through the damper.

16. The system of claim 1, wherein the first predetermined interior pressure change threshold corresponds to a presence of a vehicle at an enclosed parking structure at the premises.

17. The system of claim 16, further comprising:
a garage door actuator configured to open and close a garage door at the enclosed parking structure,
wherein the first output determined by the controller as associated with the first predetermined interior pressure change threshold is an actuation command to cause the garage door actuator to open or close the garage door at the enclosed parking structure.

18. The system of claim 17, further comprising:
a gas sensor configured to detect a concentration of gas at the enclosed parking structure, the gas sensor in communication with the controller,
wherein the controller is configured to receive the concentration of gas at the enclosed parking structure from the gas sensor, compare the concentration of gas to a first predetermined gas threshold, and, when the change in pressure within the enclosed parking structure matches the first predetermined interior pressure change threshold and the concentration of gas matches the first predetermined gas threshold, generate the actuation command to cause the garage door actuator to open the garage door.

19. The system of claim 18, wherein the first predetermined interior pressure change threshold corresponds to a presence of a vehicle with a running motor at an enclosed parking structure at the premises, and wherein the controller determines that the change in pressure within the enclosed parking structure matches the first predetermined interior pressure change threshold prior to determining that the concentration of gas matches the first predetermined gas threshold.

20. The system of claim 16, wherein the first output determined by the controller as associated with the first predetermined interior pressure change threshold is a damper adjustment command to adjust an air damper in fluid communication with the enclosed parking structure to change a volume of air passing through the damper.
